(19) United States
(12) Patent Application Publication
(10) Pub. No.: US 2026/0238820 A1
(43) Pub. Date: Aug. 13, 2026

(54) Support Of Both Texture And Depth Layers In An MV-HEVC Bitstream

(71) Applicant: Bytedance Inc., Los Angeles, CA (US)

(72) Inventors: Ye-Kui WANG, San Diego, CA (US); Li Zhang, San Diego, CA (US)

(21) Appl. No.: 19/633,789

(22) Filed: Mar. 30, 2026

Related U.S. Application Data
(63) Continuation of application No. PCT/US2024/049088, filed on Sep. 27, 2024.
(60) Provisional application No. 63/586,750, filed on Sep. 29, 2023.
(60) Provisional application No. 63/591,033, filed on Oct. 17, 2023.
(60) Provisional application No. 63/591,219, filed on Oct. 18, 2023.

(51) Int. Cl. H04N 19/597; H04N 19/186; H04N 19/30

(52) U.S. Cl. CPC H04N 19/597; H04N 19/186; H04N 19/30

(57) ABSTRACT

A mechanism for processing video data is disclosed. The mechanism determining that a current layer in a sub-bitstream (subBitstream) conforms to a multiview format range extension profile, wherein all active sequence parameter sets (SPSs) for the current layer and a reference layer of the current layer shall include a chroma format identification code (chroma_format_idc) equal to 0 only. A conversion is performed between a visual media data and a bitstream based on the multiview format range extension profile.

### CROSS-REFERENCE TO RELATED APPLICATION

This application is a continuation of International Patent Application No. PCT/US2024/049088, filed on Sep. 27, 2024, which claims the priority to and benefits of U.S. Provisional Patent Application 63/586,750, filed on Sep. 29, 2023, U.S. Provisional Patent Application 63/591,033, filed on Oct. 17, 2023, and U.S. Provisional Patent Application 63/591,219, filed on Oct. 18, 2023. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining that a current layer in a sub-bitstream (subBitstream) conforms to a multiview format range extension profile, wherein all active sequence parameter sets (SPSs) for the current layer and a reference layer of the current layer shall include a chroma format identification code (chroma_format_idc) equal to 0 only; and performing a conversion between a visual media data and a bitstream based on the multiview format range extension profile.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining that a current layer in a sub-bitstream (subBitstream) conforms to a multiview format range extension profile, wherein all active sequence parameter sets (SPSs) for the current layer and a reference layer of the current layer shall include a chroma format identification code (chroma_format_idc) equal to 0 only; and generating a bitstream based on the determining.

A fifth aspect relates to a method for storing bitstream of a video comprising: determining that a current layer in a sub-bitstream (subBitstream) conforms to a multiview format range extension profile, wherein all active sequence parameter sets (SPSs) for the current layer and a reference layer of the current layer shall include a chroma format identification code (chroma_format_idc) equal to 0 only; generating a bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram showing an example video processing system.

FIG. 2 is a block diagram of an example video processing apparatus.

FIG. 3 is a flowchart for an example method of video processing.

FIG. 4 is a block diagram that illustrates an example video coding system.

FIG. 5 is a block diagram that illustrates an example encoder.

FIG. 6 is a block diagram that illustrates an example decoder.

FIG. 7 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

### 1. INITIAL DISCUSSION

This document is related to video coding technologies. Specifically, this disclosure is related to support of both texture and depth layers in a Multiview High Efficiency Video Coding (MV-HEVC) bitstream. The ideas may be applied individually or in various combination, to any video coding standard or non-standard video codec, e.g., an amendment to the High Efficiency Video Coding (HEVC) standard.

### 2. FURTHER DISCUSSION

### 2.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized. To explore video coding technologies beyond high efficiency video coding (HEVC), the Joint Video Exploration Team (JVET) was founded by video coding experts group (VCEG) and motion picture experts group (MPEG). Further, methods have been adopted by JVET and put into the reference software named Joint Exploration Model (JEM) [2]. The JVET was later renamed to be the Joint Video Experts Team (JVET) when the Versatile Video Coding (VVC) project officially started. VVC [3] is a coding standard targeting at 50% bitrate reduction as compared to HEVC.

The Versatile Video Coding (VVC) standard (ITU-T H.266|ISO/IEC 23090-3) [3] and the associated Versatile Supplemental Enhancement Information (VSEI) standard (ITU-T H.274|ISO/IEC 23002-7) [4] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360° immersive media.

### 2.2 MV-HEVC

MV-HEVC refers to the multiview extension of HEVC, specified in Annex G of the HEVC specification (with references to some earlier clauses and subclauses). An MV-HEVC bitstream can contain multiple layers wherein each layer represents the texture component of one view. In the latest published HEVC specification, there is only one MV-HEVC profile specified, the Multiview Main profile, specified in subclause G.11.1.1 of the HEVC specification.

A texture layer is a layer with nuh_layer_id equal to i, such that DepthLayerFlag[i], DependencyId[i], and AuxId[i] are all equal to 0, and a depth layer is a layer with nuh_layer_id equal to i, such that DepthLayerFlag[i] is equal to 1 and DependencyId[i] and AuxId[i] are both equal to 0.

JVET-AE1006 [5] contains the draft text for an HEVC amendment that is being worked on by the JVET at the time of writing of this document. Among other things, JVET-AE1006 includes the support of four new profiles, namely the Multiview Main 10, Multiview Monochrome, Multiview Monochrome 10, and Multiview Monochrome 12 profiles.

The existing Multiview Main profile and the four new profiles, namely the Multiview Main 10, Multiview Monochrome, Multiview Monochrome 10, and Multiview Monochrome 12 profiles, are defined as follows:

. . .

### F.11.2 Decoder Capabilities

This subclause specifies requirements for decoders having the capability of decoding an output operation point with one or more necessary layers.

NOTE. For example, this clause specifies the requirements for a decoder supporting simultaneous decoding of the base layer and an independent non-base layer for which the independent non-base layer decoding (INBLD) capability is needed. Moreover, this subclause specifies the requirements for a decoder supporting decoding of layers conforming to profiles specified in Annex G or H.

A decoder that conforms to a list ptliList consisting of profile, tier, level and INBLD capability quadruplets (Pi, Ti, Li, InbldFlagi) for i in the range of 0 to d−1, inclusive, where d is a positive integer, shall be capable of decoding any output operation point containing b necessary layers, where b is less than or equal to d, when the following condition applies:
There exists a reordered list, orderedPtliList, of the profile, tier, level and INBLD capability quadruplets (orderedPj, orderedTj, orderedLj, orderedInbldFlagj) of the list ptliList such that all the following conditions apply for each value of j in the range of 0 to b−1, inclusive, where the variable bLayer[j] represents the j-th necessary layer in the output operation point:
   The profile to which bLayer[j] is indicated to conform is included in CompatibleProfileList for the profile orderedPj as specified in Table F.3.
   The tier to which bLayer[j] is indicated to conform is lower than or equal to the tier orderedTj.
   The level to which bLayer[j] is indicated to conform is lower than or equal to the level orderedLj.
   When the profile to which bLayer[j] is indicated to conform is a profile specified in Annex A, the value of general_inbld_flag (when OpTid of the output operation point is equal to vps_max_sub_layers_minus1) or sub_layer_inbld_flag[OpTid] (when OpTid of the output operation point is less than vps_max_sub_layers_minus1) of bLayer[j] is less than or equal to orderedInbldFlagj.

For each particular format range extensions profile specified in A.3.5, the compatible format range extensions profiles are defined as the profiles that are indicated by both of the following conditions being true:
The value of general_profile_idc is equal to 4 or general_profile_compatibility_flag[4] is equal to 1.
The value of each constraint flag listed in Table A.2 is less than or equal to the corresponding value specified in the row in Table A.2 for the particular format range extensions profile.

For each particular scalable format range extensions profile specified in H.11.1.2, the compatible scalable format range extensions profiles are defined as the profiles that are indicated by all of the following conditions being true:
The value of general_profile_idc is equal to 10 or general_profile_compatibility_flag[10] is equal to 1.
The value of each constraint flag listed in Table H.4 is less than or equal to the corresponding value specified in the row of Table H.4 for the particular scalable format range extensions profile.

TABLE F.3
Specification of CompatibleProfileList

| Profile | |
|---|---|
| for which | |
| the decoder | Profiles that the decoder shall support |
| conforms | CompatibleProfileList |
| Scalable Main | Scalable Main, Main, Main Still Picture |
| Scalable Main 10 | Scalable Main 10, Main, Main Still Picture, Main 10, |
| | Scalable Main |
| Scalable | The compatible format range extensions profiles of |
| Monochrome | the Monochrome profile, and the compatible scalable |
| | format range extensions profiles of the Scalable |
| | Monochrome profile |
| Scalable | The compatible format range extensions profiles of |
| Monochrome 12 | the Monochrome 12 profile, and the compatible |
| | scalable format range extensions profiles of the |
| | Scalable Monochrome 12 profile |
| Scalable | The compatible format range extensions profiles of |
| Monochrome 16 | the Monochrome 16 profile, and the compatible |
| | scalable format range extensions profiles of the |
| | Scalable Monochrome 16 profile |
| Scalable Main | Scalable Main, Main, Main Still Picture, the |
| 4:4:4 | compatible format range extensions profiles of the |
| | Main 4:4:4 profile, and the compatible scalable |
| | format range extensions profiles of the Scalable Main |
| | 4:4:4 profile |
| Multiview Main | Multiview Main, Main, Main Still Picture |
| Multiview | Multiview Main 10, Main, Main Still Picture, Main |
| Main 10 | 10, Multiview Main |
| Multiview | Multiview Monochrome, Monochrome |
| Monochrome | |
| Multiview | Multiview Monochrome 10, Multiview Monochrome, |
| Monochrome 10 | Monochrome 10, Monochrome |
| Multiview | Multiview Monochrome 12, Multiview Monochrome |
| Monochrome 12 | 10, Multiview Monochrome, Monochrome 12, |
| | Monochrome 10, Monochrome |
| 3D Main | 3D Main, Multiview Main, Main, Main Still Picture |

. . . .

### G.3 Definitions

The specifications in clause F.3 and its subclauses apply.

### G.11.1.1 Multiview Main and Multiview Main 10 Profiles

For a layer in an output operation point associated with an OLS in a bitstream, the layer being conforming to the Multiview Main and Multiview Main 10 profile, the following applies:
Let olsIdx be the OLS index of the OLS, the sub-bitstream subBitstream and the base layer sub-bitstream baseBitstream are derived as specified in F.11.3.

When vps_base_layer_internal_flag is equal to 1, the base layer sub-bitstream baseBitstream shall obey the following constraints:
When the layer conforms to the Multiview Main profile, the base layer sub-bitstream baseBitstream shall be indicated to conform to the Main profile.
When the layer conforms to the Multiview Main 10 profile, the base layer sub-bitstream baseBitstream shall be indicated to conform to the Main 10 or the Main profile.

The sub-bitstream subBitstream shall obey the following constraints:
All active VPSs shall have vps_num_rep_formats_minus1 in the range of 0 to 15, inclusive.
All active sequence parameter sets (SPSs) for layers in subBitstream shall have chroma_format_idc equal to 1 only.
All active SPSs for layers in subBitstream shall have transform_skip_rotation_enabled_flag, transform_skip_context_enabled_flag, implicit_rdpcm_enabled_flag, explicit_rdpcm_enabled_flag, extended_precision_processing_flag, intra_smoothing_disabled_flag, high_precision_offsets_enabled_flag, persistent_rice_adaptation_enabled_flag, and cabac_bypass_alignment_enabled_flag, when present, equal to 0 only.
Ctb Log 2SizeY derived from all active SPSs for layers in subBitstream shall be in the range of 4 to 6, inclusive.
All active picture parameter sets (PPSs) for layers in subBitstream shall have log 2_max_transform_skip_block_size_minus2 and chroma_qp_offset_list_enabled_flag, when present, equal to 0 only.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
When NumLayersInIdList[OlsIdxToLsIdx[olsIdx]] is equal to 2, output_layer_flag[olsIdx][j] derived according to any active VPS shall be equal to 1 for j in the range of 0 to 1, inclusive, for subBitstream.
All active VPSs shall have alt_output_layer_flag[olsIdx] equal to 0 only.
When ViewOrderIdx[i] derived according to any active VPS is equal to 1 for the layer with nuh_layer_id equal to i in subBitstream, inter_view_mv_vert_constraint_flag shall be equal to 1 in the sps_multilayer_extension( ) syntax structure in each active SPS for that layer.
When ViewOrderIdx[i] derived according to any active VPS is greater than to 0 for the layer with nuh_layer_id equal to i in subBitstream, num_ref_loc_offsets shall be equal to 0 in each active PPS for that layer.
When ViewOrderIdx[i] derived according to any active VPS is greater than 0 for the layer with nuh_layer_id equal to i in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
For a layer with nuh_layer_id iNuhLId equal to any value included in layerIdListTarget that was used to derive subBitstream, the value of NumRefLayers[iNuhLId], which specifies the total number of direct and indirect reference layers and is derived as specified in F.7.4.3.1, shall be less than or equal to 4.
All active SPSs for layers in subBitstream shall have sps_range_extension_flag and sps_scc_extension_flag equal to 0 only.
All active PPSs for layers in subBitstream shall have pps_range_extension_flag and pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, ViewOrderIdx[i] shall be greater than ViewOrderIdx[j] for any values of i and j among layerIdListTarget that was used to derive subBitstream such that AuxId[i] is equal to AuxId[j] and i is greater than j.

When the layer conforms to the Multiview Main profile, the sub-bitstream subBitstream shall obey the following constraints:
All active SPSs for layers in subBitstream shall have bit_depth_luma_minus8 equal to 0 only.
All active SPSs for layers in subBitstream shall have bit_depth_chroma_minus8 equal to 0 only.
All active PPSs for layers in subBitstream shall have colour_mapping_enabled_flag equal to 0 only.
The tier and level constraints specified for the Multiview Main profile in G.11.2 shall be fulfilled.

When the layer conforms to the Multiview Main 10 profile, the sub-bitstream subBitstream shall obey the following constraints:
All active SPSs for layers in subBitstream shall have bit_depth_luma_minus8 in the range of 0 to 2, inclusive.
All active SPSs for layers in subBitstream shall have bit_depth_chroma_minus8 in the range of 0 to 2, inclusive.
The tier and level constraints specified for the Multiview Main 10 profile in G.11.2 shall be fulfilled.

In the remainder of this subclause and G.11.2.1, all syntax elements in the profile_tier_level( ) syntax structure refer to those in the profile_tier_level( ) syntax structure associated with the layer.

Conformance of a layer in an output operation point associated with an OLS in a bitstream to the Multiview Main profile is indicated as follows:
If OpTid of the output operation point is equal to vps_max_sub_layer_minus1, the conformance is indicated by having both of the following conditions satisfied:
   general_profile_idc being equal to 6 or general_profile_compatibility_flag[6] being equal to 1,
   general_max_12bit_constraint_flag being equal to 1, general_max_10bit_constraint_flag being equal to 1, general_max_8bit_constraint_flag being equal to 1, general_max_422chroma_constraint_flag being equal to 1, general_max_420chroma_constraint_flag being equal to 1, general_max_monochrome_constraint_flag being equal to 0, general_intra_constraint_flag being equal to 0, general_one_picture_only_constraint_flag being equal to 0, and general_lower_bit_rate_constraint_flag being equal to 1
Otherwise (OpTid of the output operation point is less than vps_max_sub_layer_minus1), the conformance is indicated by having both of the following conditions satisfied:
   sub_layer_profile_idc[OpTid] being equal to 6 or sub_layer_profile_compatibility_flag[OpTid][6] being equal to 1
   sub_layer_max_12bit_constraint_flag[OpTid] being equal to 1, sub_layer_max_10bit_constraint_flag[OpTid] being equal to 1, sub_layer_max_8bit_constraint_flag[OpTid] being equal to 1, sub_layer_max_422chroma_constraint_flag[OpTid] being equal to 1, sub_layer_max_420chroma_constraint_flag[OpTid] being equal to 1, sub_layer_max_monochrome_constraint_flag[OpTid] being equal to 0, sub_layer_intra_constraint_flag[OpTid] being equal to 0, sub_layer_one_picture_only_constraint_flag[OpTid] being equal to 0, and sub_layer_lower_bit_rate_constraint_flag[OpTid] being equal to 1

Conformance of a layer in an output operation point associated with an OLS in a bitstream to the Multiview Main 10 profile is indicated as follows:
If OpTid of the output operation point is equal to vps_max_sub_layer_minus1, the conformance is indicated by having both of the following conditions satisfied:
   general_profile_idc being equal to 6 or general_profile_compatibility_flag[6] being equal to 1,
   general_max_12bit_constraint_flag being equal to 1, general_max_10bit_constraint_flag being equal to 1, general_max_8bit_constraint_flag being equal to 0, general_max_422chroma_constraint_flag being equal to 1, general_max_420chroma_constraint_flag being equal to 1, general_max_monochrome_constraint_flag being equal to 0, general_intra_constraint_flag being equal to 0, general_one_picture_only_constraint_flag being equal to 0, and general_lower_bit_rate_constraint_flag being equal to 1.
Otherwise (OpTid of the output operation point is less than vps_max_sub_layer_minus1), the conformance is indicated by having both of the following conditions satisfied:
   sub_layer_profile_idc[OpTid] being equal to 6 or sub_layer_profile_compatibility_flag[OpTid][6] being equal to 1
   sub_layer_max_12bit_constraint_flag[OpTid] being equal to 1, sub_layer_max_10bit_constraint_flag[OpTid] being equal to 1, sub_layer_max_8bit_constraint_flag[OpTid] being equal to 0, sub_layer_max_422chroma_constraint_flag[OpTid] being equal to 1, sub_layer_max_420chroma_constraint_flag[OpTid] being equal to 1, sub_layer_max_monochrome_constraint_flag[OpTid] being equal to 0, sub_layer_intra_constraint_flag[OpTid] being equal to 0, sub_layer_one_picture_only_constraint_flag[OpTid] being equal to 0, and sub_layer_lower_bit_rate_constraint_flag[OpTid] being equal to 1.

### G.11.1.2 Multiview Format Range Extensions Profiles

The following profiles, collectively referred to as the multiview format range extensions profiles, are specified in this subclause:
the Multiview Monochrome, Multiview Monochrome 10, and Multiview Monochrome 12 profiles.

For a layer in an output operation point associated with an OLS in a bitstream, the layer being conforming to the Multiview Monochrome, Multiview Monochrome 10, or Multiview Monochrome 12 profiles, the following applies:
Let olsIdx be the OLS index of the OLS, the sub-bitstream subBitstream and the base layer sub-bitstream baseBitstream are derived as specified in F.11.3.

When vps_base_layer_internal_flag is equal to 1, the base layer sub-bitstream baseBitstream shall obey the following constraints:
When the layer conforms to the Multiview Monochrome, the base layer sub-bitstream baseBitstream shall be indicated to conform to the Monochrome profile.
When the layer conforms to the Multiview Monochrome 10, the base layer sub-bitstream baseBitstream shall be indicated to conform to the Monochrome profile or the Monochrome 10 profile.
When the layer conforms to the Multiview Monochrome 12, the base layer sub-bitstream baseBitstream shall be indicated to conform to the Monochrome profile, the Monochrome 10 profile, or a format range extensions profile.

The sub-bitstream subBitstream shall obey the following constraints:
All active VPSs shall have vps_num_rep_formats_minus1 in the range of 0 to 15, inclusive.
All active SPSs for layers in subBitstream shall have chroma_format_idc equal to 1 only.
All active SPSs for the layers in subBitstream shall have separate_colour_plane_flag, cabac_bypass_alignment_enabled_flag, when present, equal to 0 only.
Ctb Log 2SizeY derived from all active SPSs for layers in subBitstream shall be in the range of 4 to 6, inclusive.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
The constraints specified in Table H.3, in which entries marked with “−” indicate that the table entry does not impose a profile-specific constraint on the corresponding syntax element, shall apply for all active SPSs and PPSs for layers in subBitstream.

NOTE. For some syntax elements with table entries marked with “−”, a constraint may be imposed indirectly—e.g. by semantics constraints that are imposed elsewhere in this document when other specified constraints are fulfilled.
All active SPSs for layers in subBitstream shall have the same value of chroma_format_idc.
All active SPSs for layers in subBitstream shall have sps_scc_extension_flag equal to 0 only.
All active PPSs for layers in subBitstream shall have pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, DependencyId[i] shall be greater than DependencyId[j] for any values of i and j among layerIdListTarget that was used to derive subBitstream such that AuxId[i] is equal to AuxId[j] and i is greater than j.
The tier and level constraints specified for the Multiview Monochrome, Multiview Monochrome 10, and Multiview Monochrome 12 profiles in G.11.2, as applicable, shall be fulfilled.

TABLE G.3
Allowed values for syntax elements in the multiview format range extensions profiles

| | | | transform_skip_rotation_{—} | | |
|---|---|---|---|---|---|
| | | | enabled_flag, transform_skip_{—} | | |
| | | | context_enabled_flag, | | |
| | | | implicit_rdpcm_enabled_flag, | | |
| | | | explicit_rdpcm_enabled_flag, | | |
| | | | intra_smoothing_disabled_{—} | | |
| Profile | | bit_depth_{—} | flag, persistent_rice_{—} | extended_{—} | |
| for which | chroma_{—} | luma_minus8 | adaptation_enabled_flag, | precision_{—} | chroma_qp_{—} |
| constraint | format_{—} | and bit_depth_{—} | and log2_max_transform_{—} | processing_{—} | offset_list_{—} |
| is specified | idc | chroma_minus8 | skip_block_size_minus2 | flag | enabled_flag |
| Multiview | 0 | 0 | 0 | 0 | 0 |
| Monochrome | | | | | |
| Multiview | 0 | 0 . . . 2 | 0 | 0 | 0 |
| Monochrome 10 | | | | | |
| Multiview | 0 | 0 . . . 4 | 0 | 0 | 0 |
| Monochrome 12 | | | | | |

In the remainder of this subclause and H.11.2.1, all syntax elements in the profile_tier_level( ) syntax structure refer to those in the profile_tier_level( ) syntax structure associated with the layer.

Conformance of a layer in an output operation point associated with an OLS in a bitstream for the multiview format range extensions profiles is indicated as follows:
If OpTid of the output operation point is equal to vps_max_sub_layer_minus1, the conformance is indicated by general_profile_idc being equal to 10 or general_profile_compatibility_flag[10] being equal to 1, with the additional indications specified in Table H.4 for the general constraint flags.
Otherwise (OpTid of the output operation point is less than vps_max_sub_layer_minus1), the conformance is indicated by sub_layer_profile_idc[OpTid] being equal to 10 or sub_layer_profile_compatibility_flag[OpTid][10] being equal to 1, with the additional indications specified in Table H.4 for the flags associated with the index OpTid.

All other combinations of general_max_14bit_constraint_flag, general_max_12bit_constraint_flag, general_max_10bit_constraint_flag, general_max_8bit_constraint_flag, general_max_422chroma_constraint_flag, general_max_420chroma_constraint_flag, general_max_monochrome_constraint_flag, general_intra_constraint_flag, general_one_picture_only_constraint_flag, and general_lower_bit_rate_constraint_flag with general_profile_idc equal to 10 or general_profile_compatibility_flag[10] equal to 1 are reserved for future use by ITU-T|ISO/IEC. All other combinations of sub_layer_max_14bit_constraint_flag[OpTid], sub_layer_max_12bit_constraint_flag[OpTid], sub_layer_max_10bit_constraint_flag[OpTid], sub_layer_max_8bit_constraint_flag[OpTid], sub_layer_max_422chroma_constraint_flag[OpTid], sub_layer_max_420chroma_constraint_flag[OpTid], sub_layer_max_monochrome_constraint_flag[OpTid], sub_layer_intra_constraint_flag[OpTid], sub_layer_one_picture_only_constraint_flag[OpTid], and sub_layer_lower_bit_rate_constraint_flag[OpTid] with sub_layer_profile_idc[OpTid] equal to 10 or sub_layer_profile_compatibility_flag[OpTid][10] equal to 1 are reserved for future use by ITU-T|ISO/IEC. Such combinations shall not be present in bitstreams conforming to this document. However, decoders conforming to the multiview format range extensions profiles shall allow other combinations as specified below in this clause to occur in the bitstream.

TABLE G.4
Bitstream indications for conformance to multiview range extensions profiles

| | | | | | general_{—} |
|---|---|---|---|---|---|
| | | | | | max_{—} |
| | general_{—} | general_{—} | general_{—} | general_{—} | 422chroma_{—} |
| | max_14bit_{—} | max_12bit_{—} | max_10bit_{—} | max_8bit_{—} | constraint_{—} |
| | constraint_{—} | constraint_{—} | constraint_{—} | constraint_{—} | flag or |
| Profile for | flag or | flag or | flag or | flag or | sub_layer_{—} |
| which the | sub_layer_{—} | sub_layer_{—} | sub_layer_{—} | sub_layer_{—} | max_{—} |
| bitstream | max_14bit_{—} | max_12bit_{—} | max_10bit_{—} | max_8bit_{—} | 422chroma_{—} |
| indicates | constraint_{—} | constraint_{—} | constraint_{—} | constraint_{—} | constraint_{—} |
| conformance | flag[ OpTid ] | flag[ OpTid ] | flag[ OpTid ] | flag[ OpTid ] | flag[ OpTid ] |
| Multiview | 1 | 1 | 1 | 1 | 1 |
| Monochrome | | | | | |
| Multiview | 1 | 1 | 1 | 0 | 1 |
| Monochrome | | | | | |
| 10 | | | | | |
| Multiview | 1 | 1 | 0 | 0 | 1 |
| Monochrome | | | | | |
| 12 | | | | | |
| | | | | general_{—} | |
| | | | | one_{—} | |
| | general_{—} | general_{—} | | picture_{—} | general_{—} |
| | max_{—} | max_{—} | | only_{—} | lower_{—} |
| | 420chroma_{—} | monochrome_{—} | general_{—} | constraint_{—} | bit_rate_{—} |
| | constraint_{—} | constraint_{—} | intra_{—} | flag or | constraint_{—} |
| | flag or | flag or | constraint_{—} | sub_layer_{—} | flag or |
| Profile for | sub_layer_{—} | sub_layer_{—} | flag or | one_{—} | sub_layer_{—} |
| which the | max_{—} | max_{—} | sub_layer_{—} | picture_{—} | lower_{—} |
| bitstream | 420chroma_{—} | monochrome_{—} | intra_{—} | only_{—} | bit_rate_{—} |
| indicates | constraint_{—} | constraint_{—} | constraint_{—} | constraint_{—} | constraint_{—} |
| conformance | flag[ OpTid ] | flag[ OpTid ] | flag[ OpTid ] | flag[ OpTid ] | flag[ OpTid ] |
| Multiview | 1 | 1 | 0 | 0 | 1 |
| Monochrome | | | | | |
| Multiview | 1 | 1 | 0 | 0 | 1 |
| Monochrome | | | | | |
| 10 | | | | | |
| Multiview | 1 | 1 | 0 | 0 | 1 |
| Monochrome | | | | | |
| 12 | | | | | |

. . . .

### G.11.2.1 General Tier and Level Limits

For purposes of comparison of tier capabilities, the tier with general_tier_flag or sub_layer_tier_flag[i] equal to 0 is considered to be a lower tier than the tier with general_tier_flag or sub_layer_tier_flag[i] equal to 1.

For purposes of comparison of level capabilities, a particular level of a specific tier is considered to be a lower level than some other level of the same tier when the value of the general_level_idc or sub_layer_level_idc[i] of the particular level is less than that of the other level.

The following is specified for expressing the constraints in this subclause and H.11.2.2:
For the Multiview Main profile, the value of each of the variables coded picture buffer (CPB) video coding layer (VCL) factor (CpbVclFactor), CPB network abstraction layer (NAL) factor (CpbNalFactor), FormatCapabilityFactor, and MinCrScaleFactor is the same as that specified in Table A.10 for the Main profile. For the Multiview Main 10 profile, the value of each of these variables is the same as that specified in Table A.10 for the Main 10 profile.
For the Multiview Monochrome profile, the value of each of the variables CpbVclFactor, CpbNalFactor, FormatCapabilityFactor, and MinCrScaleFactor is the same as that specified in Table A.10 for the Monochrome profile.
For the Multiview Monochrome 10 profile, the value of each of the variables CpbVclFactor, CpbNalFactor, FormatCapabilityFactor, and MinCrScaleFactor is the same as that specified in Table A.10 for the Monochrome 10 profile.
For the Multiview Monochrome 12 profile, the value of each of the variables CpbVclFactor, CpbNalFactor, FormatCapabilityFactor, and MinCrScaleFactor is the same as that specified in Table A.10 for the Monochrome 12 profile.
Let access unit n be the n-th access unit in decoding order, with the first access unit being access unit 0 (i.e. the 0-th access unit).
Let the variable fR be set as follows:
   If the bitstream or sub-layer representation is indicated to conform to the Main tier or is indicated to conform to a level that is lower than level 7.0, fR is set equal to 1÷300.
   Otherwise, fR is set equal to 1÷960.
Let the variable olsIdx be the index of the OLS.
For each layer with nuh_layer_id equal to currLayerId, let the variable layerSizeInSamplesY be derived as follows:
   layerSizeInSamplesY=pic_width_vps_in_luma_samples*pic_height_vps_in_luma_samples (G-2) where pic_width_vps_in_luma_samples and pic_height_vps_in_luma_samples are found in the vps_rep_format_idx[LayerIdxInVps[currLayerId]]-th rep_format( ) syntax structure in the video parameter set (VPS).

When the specified level is not level 8.5, each layer with nuh_layer_id equal to currLayerId conforming to a profile at a specified tier and level shall obey the following constraints for each bitstream conformance test as specified in F.13, where “access unit” is used to denote the picture unit in the layer and the CPB is understood to be the bitstream partition buffer (BPB):
a) The value of layerSizeInSamplesY shall be less than or equal to MaxLumaPs, where MaxLumaPs is specified in Table A.8 for the tier and level of the layer.
b) The value of pic_width_vps_in_luma_samples of the vps_rep_format_idx[LayerIdxInVps[currLayerId]]-th rep_format( ) syntax structure in the VPS shall be less than or equal to Sqrt(MaxLumaPs*8).
c) The value of pic_height_vps_in_luma_samples of the vps_rep_format_idx[LayerIdxInVps[currLayerId]]-th rep_format( ) syntax structure in the VPS shall be less than or equal to Sqrt(MaxLumaPs*8).
d) The value of max_vps_dec_pic_buffering_minus1[olsIdx][LayerIdxInVps[currLayerId]][HighestTid] shall be less than or equal to MaxDpbSize as derived by Formula (A-2), with PicSizeInSamplesY being replaced with layerSizeInSamplesY, for the tier and level of the layer.
e) For level 5 and higher levels, the value of CtbSizeY for the layer shall be equal to 32 or 64.
f) The value of NumPicTotalCurr for each picture in the layer shall be less than or equal to 8.
g) When decoding each coded picture in the layer, the value of num_file_columns_minus1 shall be less than MaxTileCols and num_tile_rows_minus1 shall be less than MaxTileRows, where MaxTileCols and MaxTileRows are specified in Table A.8 for the tier and level of the layer.
h) For the VCL hypothetical reference decoder (HRD) parameters of the layer, CpbSize[i] shall be less than or equal to CpbVclFactor*MaxCPB for at least one of the delivery schedules identified by bsp_sched_idx[olsIdx][0][HighestTid][combIdx][LayerIdxInVps[currLayerId]] for combIdx ranging from 0 to num_bsp_schedules_minus1[olsIdx][0][HighestTid], inclusive, where CpbSize[i] is specified in F.13.1 and MaxCPB is specified in Table A.8 for the tier and level of the layer in units of CpbVclFactor bits.
i) For the NAL HRD parameters of the layer, CpbSize[i] shall be less than or equal to CpbNalFactor*MaxCPB for at least one of the delivery schedules identified by bsp_sched_idx[olsIdx][0][HighestTid][combIdx][LayerIdxInVps[currLayerId]] for combIdx ranging from 0 to num_bsp_schedules_minus1[olsIdx][0][HighestTid], inclusive, where CpbSize[i] is specified in F.13.1 and MaxCPB is specified in Table A.8 for the tier and level of the layer in units of CpbNalFactor bits.
j) For each coded picture, the value of BinCountsInNalUnits shall be less than or equal to (32÷3)*NumBytesInVclNalUnits+(RawMinCuBits*PicSizeInMinCbsY)÷32.

Table A.8 specifies the limits for each level of each tier for levels other than level 8.5.

NOTE. Since there are no limits specified by Table A.8 for level 8.5, it is not possible in general for a practical decoder to be assured of being able to decode all bitstreams that conform to this level. The purpose of the definition of level 8.5 is to provide a suitable label for bitstreams that can exceed the limits of all other specified levels. When the bitstream is indicated to conform to level 8.5, a decoder is expected to examine the characteristics of the bitstream during its operation in order to determine whether it is capable of decoding the bitstream.

A tier and level to which a layer in an output operation point associated with an OLS in a bitstream conforms are indicated by the syntax elements general_tier_flag and general_level_idc if OpTid of the output layer set is equal to vps_max_sub_layer_minus1, and by the syntax elements sub_layer_tier_flag[OpTid] and sub_layer_level_idc[OpTid] otherwise, as follows:
If the specified level is not level 8.5, general_tier_flag or sub_layer_tier_flag[OpTid] equal to 0 indicates conformance to the Main tier, and general_tier_flag or sub_layer_tier_flag[OpTid] equal to 1 indicates conformance to the High tier, according to the tier constraints specified in Table A.8, and general_tier_flag and sub_layer_tier_flag[OpTid] shall be equal to 0 for levels below level 4 (corresponding to the entries in Table A.8 marked with “−”). Otherwise (the specified level is level 8.5), it is a requirement of bitstream conformance that general_tier_flag and sub_layer_tier_flag[OpTid] shall be equal to 1 and the value 0 for general_tier_flag and sub_layer_tier_flag[OpTid] is reserved for future use by ITU-T|ISO/IEC, and decoders shall ignore the value of general_tier_flag and sub_layer_tier_flag[OpTid].
general_level_idc and sub_layer_level_idc[OpTid] shall be set equal to a value of 30 times the level number specified in Table A.8.
   . . . .

### G.11.2.2 Profile-Specific Tier and Level Limits for the Multiview Main, Multiview Main 10, and Multiview Format Range Extensions Profiles

The following is specified for expressing the constraints in this subclause:
The variable HbrFactor is set equal to 1.
The variable BrVclFactor is set equal to CpbVclFactor*HbrFactor.
The variable BrNalFactor is set equal to CpbNalFactor*HbrFactor.
The variable MinCr is set equal to MinCrBase*MinCrScaleFactor÷HbrFactor, where MinCrBase is specified in Table A.9.

When the specified level is not level 8.5, each layer conforming to the Multiview Main, Multiview Main 10 profiles, or the multiview format range extensions profiles at a specified tier and level shall obey the following constraints for each conformance test as specified in F.13, where “access unit” is used to denote the picture unit in the layer, and the CPB is understood to be the BPB:
a) The nominal removal time of access unit n (with n greater than 0) from the CPB, as specified in F.13.2.3, shall satisfy the constraint that AuNominalRemovalTime[n]−AuCpbRemovalTime[n−1] is greater than or equal to Max(layerSizeInSamplesY÷MaxLumaSr, fR), where layerSizeInSamplesY is the value of layerSizeInSamplesY for access unit n−1 and MaxLumaSr is the value specified in Table A.9 that applies to access unit n−1 for the tier and level of the layer.
b) The difference between consecutive output times of pictures in different access units, as specified in F.13.3.3, shall satisfy the constraint that DpbOutputInterval[n] is greater than or equal to Max(layerSizeInSamplesY÷MaxLumaSr, fR), where layerSizeInSamplesY is the value of layerSizeInSamplesY of access unit n and MaxLumaSr is the value specified in Table A.9 for access unit n for the tier and level of the layer, provided that access unit n is an access unit that has a picture that is output and is not the last of such access units.
c) The removal time of access unit 0 shall satisfy the constraint that the number of coded slice segments in access unit 0 is less than or equal to Min(Max(1, MaxSliceSegmentsPerPicture*MaxLumaSr/MaxLumaPs*(AuCpbRemovalTime[0]−AuNominalRemovalTime[0])+MaxSliceSegmentsPerPicture*layerSizeInSamplesY/MaxLumaPs), MaxSliceSegmentsPerPicture), for the value of layerSizeInSamplesY of access unit 0, where MaxSliceSegmentsPerPicture, MaxLumaPs, and MaxLumaSr are the values specified in Table A.8 and Table A.9 for the tier and level of the layer.
d) The difference between consecutive CPB removal times of access units n and n−1 (with n greater than 0) shall satisfy the constraint that the number of slice segments in access unit n is less than or equal to Min(Max(1, MaxSliceSegmentsPerPicture*MaxLumaSr/MaxLumaPs*(AuCpbRemovalTime[n]−AuCpbRemovalTime[n−1])), MaxSliceSegmentsPerPicture), where MaxSliceSegmentsPerPicture, MaxLumaPs, and MaxLumaSr are the values specified in Table A.8 and Table A.9 that apply to access unit n for the tier and level of the layer.
e) For the VCL HRD parameters for the layer, BitRate[i] shall be less than or equal to bit rate (BR) VCL factor (BrVclFactor)*maximum BR (MaxBR) for at least one of the delivery schedules identified by bsp_sched_idx[olsIdx][0][HighestTid][combIdx][LayerIdxInVps[currLayerId]] for combIdx ranging from 0 to num_bsp_schedules_minus1[olsIdx][0][HighestTid], inclusive, where BitRate[i] is specified in F.13.1 and MaxBR is specified in Table A.9 in units of BrVclFactor bits/s for the tier and level of the layer.
f) For the NAL HRD parameters for the layer, BitRate[i] shall be less than or equal to BrNalFactor*MaxBR for at least one of the delivery schedules identified by bsp_sched_idx[olsIdx][0][HighestTid][combIdx][LayerIdxInVps[currLayerId]] for combIdx ranging from 0 to num_bsp_schedules_minus1[olsIdx][0][HighestTid], inclusive, where BitRate[i] is specified in F.13.1 and MaxBR is specified in Table A.9 in units of BrNalFactor bits/s for the tier and level of the layer.
g) The sum of the NumBytesInNalUnit variables for access unit 0 shall be less than or equal to FormatCapabilityFactor*(Max(layerSizeInSamplesY, fR*MaxLumaSr)+MaxLumaSr*(AuCpbRemovalTime[0]−AuNominalRemovalTime[0]))÷MinCr for the value of layerSizeInSamplesY of access unit 0, where MaxLumaSr is specified in Table A.9, and both MaxLumaSr and FormatCapabilityFactor are the values that apply to access unit 0 for the tier and level of the layer.
h) The sum of the NumBytesInNalUnit variables for access unit n (with n greater than 0) shall be less than or equal to FormatCapabilityFactor*MaxLumaSr*(AuCpbRemovalTime[n]−AuCpbRemovalTime[n−1])÷MinCr, where MaxLumaSr is specified in Table A.9, and both MaxLumaSr and FormatCapabilityFactor are the values that apply to access unit n for the tier and level of the layer.
i) The removal time of access unit 0 shall satisfy the constraint that the number of tiles in coded pictures in access unit 0 is less than or equal to Min(Max(1, MaxTileCols*MaxTileRows*120*(AuCpbRemovalTime[0]−AuNominalRemovalTime[0])+MaxTileCols*MaxTileRows*PicSizeInSamplesY/MaxLumaPs), MaxTileCols*MaxTileRows), for the value of layerSizeInSamplesY of access unit 0, where MaxTileCols and MaxTileRows are the values specified in Table A.8 that apply to access unit 0 for the tier and level of the layer.
j) The difference between consecutive CPB removal times of access units n and n−1 (with n greater than 0) shall satisfy the constraint that the number of tiles in coded pictures in access unit n is less than or equal to Min(Max(1, MaxTileCols*MaxTileRows*120*(AuCpbRemovalTime[n]−AuCpbRemovalTime[n−1])), MaxTileCols*MaxTileRows), where MaxTileCols and MaxTileRows are the values specified in Table A.8 that apply to access unit n for the tier and level of the layer.
   . . . .

### 3. TECHNICAL PROBLEMS SOLVED BY DISCLOSED TECHNICAL SOLUTIONS

Although the syntax of MV-HEVC allows for an output layer set (OLS) in an MV-HEVC bitstream to have both texture layers and depth layers, the profile definitions do not allow this. Applications have been developed, e.g., virtual reality, that benefit from all the following three aspects simultaneously: 1) using inter-view prediction between different views, 2) having depths associated with the coded views to be available to the decoder and the renderer, and 3) using HEVC hardware encoder/decoder designs. Furthermore, in such applications it is desirable that the bit depth of the depth component can be of up to 16 bits. Therefore, there lacks a proper profile definition that enables an OLS in an MV-HEVC bitstream to have both texture layers and depth layers. In addition, for certain applications, there is no need to transmit depth layers in the same spatial resolution as texture layers.

### 4. A LISTING OF SOLUTIONS AND EMBODIMENTS

To solve the above-described problems, methods as summarized below are disclosed. The aspects should be considered as examples to explain the general concepts and should not be interpreted in a narrow way. Furthermore, these examples can be applied individually or combined in any manner.
1) A new profile, namely the Multiview Monochrome 16 profile, is defined, and this new profile is characterized by one or more of the following aspects:
   a. The CompatibleProfileList of this new profile consists of the following profiles: Multiview Monochrome 16, Multiview Monochrome 12, Multiview Monochrome 10, Multiview Monochrome, Monochrome 16, Monochrome 12, Monochrome 10, Monochrome.
   b. For a layer conforming to the Multiview Monochrome 16 profile, the value of chroma_format_idc is restricted to be equal to 0 only, the value of each of bit_depth_luma_minus8 and bit_depth_chroma_minus8 is restricted to be in the range of 0 to 8, inclusive, the value of each of transform_skip_rotation_enabled_flag, transform_skip_context_enabled_flag, implicit_rdpcm_enabled_flag, explicit_rdpcm_enabled_flag, intra_smoothing_disabled_flag, persistent_rice_adaptation_enabled_flag, log 2_max_transform_skip_block_size_minus2, extended_precision_processing_flag, and chroma_qp_offset_list_enabled_flag is restricted to be equal to 0 only.
   c. For a layer conforming to the Multiview Monochrome 16 profile, the value of each of general_max_14bit_constraint_flag, sub_layer_max_14bit_constraint_flag[OpTid], general_max_12bit_constraint_flag, sub_layer_max_12bit_constraint_flag[OpTid], general_max_10bit_constraint_flag, sub_layer_max_10bit_constraint_flag[OpTid], general_max_8bit_constraint_flag, sub_layer_max_8bit_constraint_flag[OpTid], general_intra_constraint_flag, sub_layer_intra_constraint_flag[OpTid], general_one_picture_only_constraint_flag and sub_layer_one_picture_only_constraint_flag[OpTid] is restricted to be equal to 0 only, and the value of each of general_max_422chroma_constraint_flag, sub_layer_max_422chroma_constraint_flag[OpTid], general_max_420chroma_constraint_flag, sub_layer_max_420chroma_constraint_flag[OpTid], general_max_monochrome_constraint_flag, sub_layer_max_monochrome_constraint_flag[OpTid], general_lower_bit_rate_constraint_flag, and sub_layer_lower_bit_rate_constraint_flag[OpTid] is restricted to be equal to 1 only.
   d. For the Multiview Monochrome 16 profile, the value of each of the variables CpbVclFactor, CpbNalFactor, FormatCapabilityFactor, and MinCrScaleFactor is the same as that specified in Table A.10 for the Monochrome 16 profile.
   e. It is allowed for an output layer set (OLS) containing a layer conforming to the Multiview Monochrome 16 profile to have both texture layers and depth layers.
   f. When a layer in an OLS conforms to the Multiview Monochrome 16 profile, one or more of the following bitstream constraints are applied, wherein subBitstream is the bitstream of the OLS:
      i. No restriction is imposed on the profile to which the base layer of subBitstream conforms.
      ii. All active SPSs for a layer conforming to the Multiview Monochrome 16 profile in subBitstream shall have chroma_format_idc equal to 0 only.
      iii. ScalabilityId[j][smIdx] derived according to any active VPS shall be equal to 0 for any smIdx value not equal to 0 or 1 and for any value of j such that layer_id_in_nuh[j] is among layerIdListTarget that was used to derive subBitstream.
      iv. For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, the value of bit_depth_luma_minus8 for layerA and the value of bit_depth_luma_minus8 for layerB shall be identical, the value of bit_depth_chroma_minus8 for layerA and the value of bit_depth_chroma_minus8 for layerB shall be identical, and DepthLayerFlag[i] shall be equal to DepthLayerFlag[j].
      v. For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
      vi. When there are two different layers, a texture layer and a depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the depth layer shall be less than or equal to the values of pic_width_in_luma_samples and pic_height_in_luma_samples, respectively, in each active SPS for the texture layer.
2) The definition of the Multiview Main 10 profile is updated with one or more of the following new aspects:
   a. It is allowed for an output layer set (OLS) containing a layer conforming to the Multiview Main 10 profile to have both texture layers and depth layers.
   b. When a layer in an OLS conforms to the Multiview Main 10 profile, one or more of the following bitstream constraints are applied, wherein subBitstream is the bitstream of the OLS:
      i. All active SPSs for a texture layer in subBitstream shall have chroma_format_idc equal to 1 only, and all active SPSs for a depth layer in subBitstream shall have chroma_format_idc equal to 0 only.
      ii. For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, and DepthLayerFlag[i] shall be equal to DepthLayerFlag[j].
      iii. ScalabilityId[j][smIdx] derived according to any active VPS shall be equal to 0 for any smIdx value not equal to 0 or 1 and for any value of j such that layer_id_in_nuh[j] is among layerIdListTarget that was used to derive subBitstream.
      iv. All active SPSs for a texture layer in subBitstream shall have bit_depth_luma_minus8 in the range of 0 to 2, inclusive, and all active SPSs for a depth layer in subBitstream shall have bit_depth_luma_minus8 in the range of 0 to 8, inclusive.
      v. All active SPSs for a layer with nuh_layer_id equal to i and DepthLayerFlag[i] equal to 0 in subBitstream shall have bit_depth_chroma_minus8 in the range of 0 to 2, inclusive, and all active SPSs for a layer with nuh_layer_id equal to i and DepthLayerFlag[i] equal to 1 in subBitstream shall have bit_depth_chroma_minus8 in the range of 0 to 8, inclusive.
      vi. For a layer layerA with nuh_layer_id equal to i in subBitstream and another layer layerB with nuh_layer_id equal to j, when layerB is a reference layer of layerA, the value of bit_depth_luma_minus8 for layerA and the value of bit_depth_luma_minus8 for layerB shall be identical, and the value of bit_depth_chroma_minus8 for layerA and the value of bit_depth_chroma_minus8 for layerB shall be identical.
      vii. For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
      viii. When there are two different layers, a texture layer and a depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the depth layer shall be less than or equal to the values of pic_width_in_luma_samples and pic_height_in_luma_samples, respectively, in each active SPS for the texture layer.
3) The definition of the Multiview Monochrome, Multiview Monochrome 10, and Multiview Monochrome 12 profiles are updated with one or more of the following new aspects:
   a. It is allowed for an output layer set (OLS) containing a layer conforming to the Multiview Monochrome, Multiview Monochrome 10, or Multiview Monochrome 12 profile to have both texture layers and depth layers.
   b. When a layer in an OLS conforms to the Multiview Monochrome, Multiview Monochrome 10, or Multiview Monochrome 12 profile, one or more of the following bitstream constraints are applied, wherein subBitstream is the bitstream of the OLS:
      i. No restriction is imposed on the profile to which the base layer of subBitstream conforms.
      ii. All active SPSs for a layer conforming to the Multiview Monochrome, Multiview Monochrome 10, or Multiview Monochrome 12 profile in subBitstream shall have chroma_format_idc equal to 0 only.
      iii. ScalabilityId[j][smIdx] derived according to any active VPS shall be equal to 0 for any smIdx value not equal to 0 or 1 and for any value of j such that layer_id_in_nuh[j] is among layerIdListTarget that was used to derive subBitstream.
      iv. For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, the value of bit_depth_luma_minus8 for layerA and the value of bit_depth_luma_minus8 for layerB shall be identical, the value of bit_depth_chroma_minus8 for layerA and the value of bit_depth_chroma_minus8 for layerB shall be identical, and DepthLayerFlag[i] shall be equal to DepthLayerFlag[j].
      v. For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
      vi. When there are two different layers, a texture layer and a depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the depth layer shall be less than or equal to the values of pic_width_in_luma_samples and pic_height_in_luma_samples, respectively, in each active SPS for the texture layer.
4) It is required that the bit-depth of depth layer shall be no smaller than the luma bit-depth of texture layer.

### 5. EMBODIMENTS

Below are some example embodiments for the aspects summarized above in Section 4.

Most relevant parts that have been added or modified are in bold, and some of the deleted parts are in bold and italic fonts. There may be some other changes that are editorial in nature and thus not indicated.

### 5.1 Embodiment 1

This embodiment is for all items and sub-items as summarized above in Section 4.

. . . .

### F.11.2 Decoder Capabilities

. . .

TABLE F.3
Specification of CompatibleProfileList

| Profile | |
|---|---|
| for which | |
| the decoder | Profiles that the decoder shall support |
| conforms | CompatibleProfileList |
| Scalable Main | Scalable Main, Main, Main Still Picture |
| Scalable Main 10 | Scalable Main 10, Main, Main Still Picture, Main 10, |
| | Scalable Main |
| Scalable | The compatible format range extensions profiles of |
| Monochrome | the Monochrome profile, and the compatible scalable |
| | format range extensions profiles of the Scalable |
| | Monochrome profile |
| Scalable | The compatible format range extensions profiles of |
| Monochrome 12 | the Monochrome 12 profile, and the compatible |
| | scalable format range extensions profiles of the |
| | Scalable Monochrome 12 profile |
| Scalable | The compatible format range extensions profiles of |
| Monochrome 16 | the Monochrome 16 profile, and the compatible |
| | scalable format range extensions profiles of the |
| | Scalable Monochrome 16 profile |
| Scalable Main | Scalable Main, Main, Main Still Picture, the |
| 4:4:4 | compatible format range extensions profiles of the |
| | Main 4:4:4 profile, and the compatible scalable |
| | format range extensions profiles of the Scalable Main |
| | 4:4:4 profile |
| Multiview Main | Multiview Main, Main, Main Still Picture |
| Multiview | Multiview Main 10, Main, Main Still Picture, Main |
| Main 10 | 10, Multiview Main |
| Multiview | Multiview Monochrome, Monochrome |
| Monochrome | |
| Multiview | Multiview Monochrome 10, Multiview Monochrome, |
| Monochrome 10 | Monochrome 10, Monochrome |
| Multiview | Multiview Monochrome 12, Multiview Monochrome |
| Monochrome 12 | 10, Multiview Monochrome, Monochrome 12, |
| | Monochrome 10, Monochrome |
| Multiview | Multiview Monochrome 16, Multiview |
| Monochrome 16 | Monochrome 12, Multiview Monochrome 10, |
| | Multiview Monochrome, Monochrome 16, |
| | Monochrome 12, Monochrome 10, Monochrome |
| 3D Main | 3D Main, Multiview Main, Main, Main Still Picture |

. . . .

### G.3 Definitions

The specifications in clause F.3 and its subclauses apply.
For the purpose of this annex, the following definitions apply in addition to the definitions in clause F.3.
depth layer: A layer with a nuh_layer_id value equal to i, such that DepthLayerFlag[i] is equal to 1 and DependencyId[i] and AuxId[i] are both equal to 0.
texture layer: A layer with a nuh_layer_id value equal to i, such that DepthLayerFlag[i], DependencyId[i], and AuxId[i] are all equal to 0.
   . . . .

### G.11.1.1 Multiview Main and Multiview Main 10 Profiles

For a layer in an output operation point associated with an OLS in a bitstream, the layer being conforming to the Multiview Main or and—Multiview Main 10 profile, the following applies:
Let olsIdx be the OLS index of the OLS, the sub-bitstream subBitstream and the base layer sub-bitstream baseBitstream are derived as specified in F.11.3.
   When vps_base_layer_internal_flag is equal to 1, the base layer sub-bitstream baseBitstream shall obey the following constraints:
When the layer conforms to the Multiview Main profile, the base layer sub-bitstream baseBitstream shall be indicated to conform to the Main profile.
When the layer conforms to the Multiview Main 10 profile, the base layer sub-bitstream baseBitstream shall be indicated to conform to the Main 10 or the Main profile.
   The sub-bitstream subBitstream shall obey the following constraints:
All active VPSs shall have vps_num_rep_formats_minus1 in the range of 0 to 15, inclusive.
When the layer conforms to the Multiview Main profile, all All active SPSs for layers in subBitstream shall have chroma_format_idc equal to 1 only.
When the layer conforms to the Multiview Main 10 profile, all active SPSs for a texture layer in subBitstream shall have chroma_format_idc equal to 1 only, and all active SPSs for a depth layer in subBitstream shall have chroma_format_idc equal to 0 only.
When the layer conforms to the Multiview Main 10 profile, for a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, and DepthLayerFlag[i] shall be equal to DepthLayerFlag[j].
All active SPSs for layers in subBitstream shall have transform_skip_rotation_enabled_flag, transform_skip_context_enabled_flag, implicit_rdpcm_enabled_flag, explicit_rdpcm_enabled_flag, extended_precision_processing_flag, intra_smoothing_disabled_flag, high_precision_offsets_enabled_flag, persistent_rice_adaptation_enabled_flag, and cabac_bypass_alignment_enabled_flag, when present, equal to 0 only.
Ctb Log 2SizeY derived from all active SPSs for layers in subBitstream shall be in the range of 4 to 6, inclusive.
All active PPSs for layers in subBitstream shall have log 2_max_transform_skip_block_size_minus2 and chroma_qp_offset_list_enabled_flag, when present, equal to 0 only.
When the layer conforms to the Multiview Main profile, ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
When the layer conforms to the Multiview Main 10 profile, ScalabilityId[j][smIdx] derived according to any active VPS shall be equal to 0 for any smIdx value not equal to 0 or 1 and for any value of j such that layer_id_in_nuh[j] is among layerIdListTarget that was used to derive subBitstream.
When NumLayersInIdList[OlsIdxToLsIdx[olsIdx]] is equal to 2, output_layer_flag[olsIdx][j] derived according to any active VPS shall be equal to 1 for j in the range of 0 to 1, inclusive, for subBitstream.
All active VPSs shall have alt_output_layer_flag[olsIdx] equal to 0 only.
When ViewOrderIdx[i] derived according to any active VPS is equal to 1 for the layer with nuh_layer_id equal to i in subBitstream, inter_view_mv_vert_constraint_flag shall be equal to 1 in the sps_multilayer_extension( ) syntax structure in each active SPS for that layer.
When ViewOrderIdx[i] derived according to any active VPS is greater than to 0 for the layer with nuh_layer_id equal to i in subBitstream, num_ref_loc_offsets shall be equal to 0 in each active PPS for that layer.
When the layer conforms to the Multiview Main profile and ViewOrderIdx[i] derived according to any active VPS is greater than 0 for the layer with nuh_layer_id equal to i in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When the layer conforms to the Multiview Main 10 profile, for any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When the layer conforms to the Multiview Main 10 profile and there are two different layers, a texture layer and a depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the depth layer shall be less than or equal to the values of pic_width_in_luma_samples and pic_height_in_luma_samples, respectively, in each active SPS for the texture layer.
For a layer with nuh_layer_id iNuhLId equal to any value included in layerIdListTarget that was used to derive subBitstream, the value of NumRefLayers[iNuhLId], which specifies the total number of direct and indirect reference layers and is derived as specified in F.7.4.3.1, shall be less than or equal to 4.
All active SPSs for layers in subBitstream shall have sps_range_extension_flag and sps_scc_extension_flag equal to 0 only.
All active PPSs for layers in subBitstream shall have pps_range_extension_flag and pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any coding_tree_unit (CTU) shall be less than or equal to 5*RawCtuBits/3.
For any active VPS, ViewOrderIdx[i] shall be greater than ViewOrderIdx[j] for any values of i and j among layerIdListTarget that was used to derive subBitstream such that AuxId[i] is equal to AuxId[j] and i is greater than j.
All active PPSs for in subBitstream shall have colour_mapping_enabled_flag equal to 0 only.
   When the layer conforms to the Multiview Main profile, the sub-bitstream subBitstream shall obey the following constraints:
All active SPSs for layers in subBitstream shall have bit_depth_luma_minus8 equal to 0 only.
All active SPSs for layers in subBitstream shall have bit_depth_chroma_minus8 equal to 0 only.
All active PPSs for layers in subBitstream shall have colour_mapping_enabled_flag equal to 0 only.
The tier and level constraints specified for the Multiview Main profile in G.11.2 shall be fulfilled.
   When the layer conforms to the Multiview Main 10 profile, the sub-bitstream subBitstream shall obey the following constraints:
All active SPSs for layers a texture layer in subBitstream shall have bit_depth_luma_minus8 in the range of 0 to 2, inclusive, and all active SPSs for a depth layer in subBitstream shall have bit_depth_luma_minus8 in the range of 0 to 8, inclusive.
All active SPSs for layers a texture layer in subBitstream shall have bit_depth_chroma_minus8 in the range of 0 to 2, inclusive, and all active SPSs for a depth layer in subBitstream shall have bit_depth_chroma_minus8 in the range of 0 to 8, inclusive.
For a layer layerA with nuh_layer_id equal to i in subBitstream and another layer layerB with nuh_layer_id equal to j, when layerB is a reference layer of layerA, the value of bit_depth_luma_minus8 for layerA and the value of bit_depth_luma_minus8 for layerB shall be identical, and the value of bit_depth_chroma_minus8 for layerA and the value of bit_depth_chroma_minus8 for layerB shall be identical.
The tier and level constraints specified for the Multiview Main 10 profile in G.11.2 shall be fulfilled.
   In the remainder of this subclause and G.11.2.1, all syntax elements in the profile_tier_level( ) syntax structure refer to those in the profile_tier_level( ) syntax structure associated with the layer.
   . . . .

### G.11.1.2 Multiview Format Range Extensions Profiles

The following profiles, collectively referred to as the multiview format range extensions profiles, are specified in this subclause:
the Multiview Monochrome, Multiview Monochrome 10, and Multiview Monochrome 12, and Multiview Monochrome 16 profiles.
   For a layer in an output operation point associated with an OLS in a bitstream, the layer being conforming to the Multiview Monochrome, Multiview Monochrome 10, or Multiview Monochrome 12, or Multiview Monochrome 16 profile, the following applies:
Let olsIdx be the OLS index of the OLS, the sub-bitstream subBitstream and the base layer sub-bitstream baseBitstream are is derived as specified in F.11.3.
   When vps_base_layer_internal_flag is equal to 1, the base layer sub-bitstream baseBitstream shall obey the following constraints:
When the layer conforms to the Multiview Monochrome, the base layer sub-bitstream baseBitstream shall be indicated to conform to the Monochrome profile.
When the layer conforms to the Multiview Monochrome 10, the base layer sub-bitstream baseBitstream shall be indicated to conform to the Monochrome profile or the Monochrome 10 profile.
When the layer conforms to the Multiview Monochrome 12, the base layer sub-bitstream baseBitstream shall be indicated to conform to the Monochrome profile, the Monochrome 10 profile, or a format range extensions profile
   The sub-bitstream subBitstream shall obey the following constraints:
All active VPSs shall have vps_num_rep_formats_minus1 in the range of 0 to 15, inclusive.
All active SPSs for layers a layer conforming to the Multiview Monochrome, Multiview Monochrome 10, Multiview Monochrome 12 or Multiview Monochrome 16 profile in subBitstream shall have chroma_format_idc equal to 10 only.
All active SPSs for layers in subBitstream shall have separate_colour_plane_flag, cabac_bypass_alignment_enabled_flag, when present, equal to 0 only.
Ctb Log 2SizeY derived from all active SPSs for layers in subBitstream shall be in the range of 4 to 6, inclusive.
ScalabilityId[j][smIdx] derived according to any active VPS shall be equal to 0 for any smIdx value not equal to 1 or 3 0 or 1 and for any value of j such that layer_id_in_nuh[j] is among layerIdListTarget that was used to derive subBitstream.
The constraints specified in Table H.3, in which entries marked with “−” indicate that the table entry does not impose a profile-specific constraint on the corresponding syntax element, shall apply for all active SPSs and PPSs for layers in subBitstream.
NOTE For some syntax elements with table entries marked with “−”, a constraint may be imposed indirectly—e.g. by semantics constraints that are imposed elsewhere in this document when other specified constraints are fulfilled.
For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, the value of bit_depth_luma_minus8 for layerA and the value of bit_depth_luma_minus8 for layerB shall be identical, the value of bit_depth_chroma_minus8 for layerA and the value of bit_depth_chroma_minus8 for layerB shall be identical, and DepthLayerFlag[i] shall be equal to DepthLayerFlag[j].
For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When there are two different layers, a texture layer and a depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the depth layer shall be less than or equal to the values of pic_width_in_luma_samples and pic_height_in_luma_samples, respectively, in each active SPS for the texture layer.
All active SPSs for layers in subBitstream shall have sps_scc_extension_flag equal to 0 only.
All active PPSs for layers in subBitstream shall have pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of limes read_bits(1) is called in 9.3.4.3.3 and 9.3.4.3.4 when parsing coding_tree_unit( ) data for any CTU shall be less than or equal to 5*RawCtuBits/3.
For any active VPS, DependencyId[i] shall be greater than DependencyId[j] for any values of i and j among layerIdListTarget that was used to derive subBitstream such that AuxId[i] is equal to AuxId[j] and i is greater than j.
The tier and level constraints specified for the Multiview Monochrome, Multiview Monochrome 10, and Multiview Monochrome 12 profiles in G.11.2, as applicable, shall be fulfilled.

TABLE G.3
Allowed values for syntax elements in the multiview format range extensions profiles

| | | | transform_skip_rotation_{—} | | |
|---|---|---|---|---|---|
| | | | enabled_flag, transform_skip_{—} | | |
| | | | context_enabled_flag, | | |
| | | | implicit_rdpcm_enabled_flag, | | |
| | | | explicit_rdpcm_enabled_flag, | | |
| | | | intra_smoothing_disabled_{—} | | |
| Profile | | bit_depth_{—} | flag, persistent_rice_{—} | extended_{—} | |
| for which | chroma_{—} | luma_minus8 | adaptation_enabled_flag, | precision_{—} | chroma_qp_{—} |
| constraint | format_{—} | and bit_depth_{—} | and log2_max_transform_{—} | processing_{—} | offset_list_{—} |
| is specified | idc | chroma_minus8 | skip_block_size_minus2 | flag | enabled_flag |
| Multiview | 0 | 0 | 0 | 0 | 0 |
| Monochrome | | | | | |
| Multiview | 0 | 0 . . . 2 | 0 | 0 | 0 |
| Monochrome 10 | | | | | |
| Multiview | 0 | 0 . . . 4 | 0 | 0 | 0 |
| Monochrome 12 | | | | | |
| Multiview | 0 | 0 . . . 8 | 0 | 0 | 0 |
| Monochrome 16 | | | | | |

In the remainder of this subclause and H.11.2.1, all syntax elements in the profile_tier_level( ) syntax structure refer to those in the profile_tier_level( ) syntax structure associated with the layer.
Conformance of a layer in an output operation point associated with an OLS in a bitstream for the multiview format range extensions profiles is indicated as follows:
If OpTid of the output operation point is equal to vps_max_sub_layer_minus1, the conformance is indicated by general_profile_idc being equal to 10 or general_profile_compatibility_flag[10] being equal to 1, with the additional indications specified in Table H.4 for the general constraint flags.
Otherwise (OpTid of the output operation point is less than vps_max_sub_layer_minus1), the conformance is indicated by sub_layer_profile_idc[OpTid] being equal to 10 or sub_layer_profile_compatibility_flag[OpTid][10] being equal to 1, with the additional indications specified in Table H.4 for the flags associated with the index OpTid.
   All other combinations of general_max_14bit_constraint_flag, general_max_12bit_constraint_flag, general_max_10bit_constraint_flag, general_max_8bit_constraint_flag, general_max_422chroma_constraint_flag, general_max_420chroma_constraint_flag, general_max_monochrome_constraint_flag, general_intra_constraint_flag, general_one_picture_only_constraint_flag, and general_lower_bit_rate_constraint_flag with general_profile_idc equal to 10 or general_profile_compatibility_flag[10] equal to 1 are reserved for future use by ITU-T|ISO/IEC. All other combinations of sub_layer_max_14bit_constraint_flag[OpTid], sub_layer_max_12bit_constraint_flag[OpTid], sub_layer_max_10bit_constraint_flag[OpTid], sub_layer_max_8bit_constraint_flag[OpTid], sub_layer_max_422chroma_constraint_flag[OpTid], sub_layer_max_420chroma_constraint_flag[OpTid], sub_layer_max_monochrome_constraint_flag[OpTid], sub_layer_intra_constraint_flag[OpTid], sub_layer_one_picture_only_constraint_flag[OpTid], and sub_layer_lower_bit_rate_constraint_flag[OpTid] with sub_layer_profile_idc[OpTid] equal to 10 or sub_layer_profile_compatibility_flag[OpTid][10] equal to 1 are reserved for future use by ITU-T|ISO/IEC. Such combinations shall not be present in bitstreams conforming to this document. However, decoders conforming to the multiview format range extensions profiles shall allow other combinations as specified below in this clause to occur in the bitstream.

TABLE G.4
Bitstream indications for conformance to multiview range extensions profiles

| | | | | | general_{—} |
|---|---|---|---|---|---|
| | | | | | max_{—} |
| | general_{—} | general_{—} | general_{—} | general_{—} | 422chroma_{—} |
| | max_14bit_{—} | max_12bit_{—} | max_10bit_{—} | max_8bit_{—} | constraint_{—} |
| | constraint_{—} | constraint_{—} | constraint_{—} | constraint_{—} | flag or |
| Profile for | flag or | flag or | flag or | flag or | sub_layer_{—} |
| which the | sub_layer_{—} | sub_layer_{—} | sub_layer_{—} | sub_layer_{—} | max_{—} |
| bitstream | max_14bit_{—} | max_12bit_{—} | max_10bit_{—} | max_8bit_{—} | 422chroma_{—} |
| indicates | constraint_{—} | constraint_{—} | constraint_{—} | constraint_{—} | constraint_{—} |
| conformance | flag[ OpTid ] | flag[ OpTid ] | flag[ OpTid ] | flag[ OpTid ] | flag[ OpTid ] |
| Multiview | 1 | 1 | 1 | 1 | 1 |
| Monochrome | | | | | |
| Multiview | 1 | 1 | 1 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 0 | 0 | 0 | 0 | 1 |
| Monochrome | | | | | |
| 16 | | | | | |
| | | | | general_{—} | |
| | | | | one_{—} | |
| | general_{—} | general_{—} | | picture_{—} | general_{—} |
| | max_{—} | max_{—} | | only_{—} | lower_{—} |
| | 420chroma_{—} | monochrome_{—} | general_{—} | constraint_{—} | bit_rate_{—} |
| | constraint_{—} | constraint_{—} | intra_{—} | flag or | constraint_{—} |
| | flag or | flag or | constraint_{—} | sub_layer_{—} | flag or |
| Profile for | sub_layer_{—} | sub_layer_{—} | flag or | one_{—} | sub_layer_{—} |
| which the | max_{—} | max_{—} | sub_layer_{—} | picture_{—} | lower_{—} |
| bitstream | 420chroma_{—} | monochrome_{—} | intra_{—} | only_{—} | bit_rate_{—} |
| indicates | constraint_{—} | constraint_{—} | constraint | constraint_{—} | constraint_{—} |
| conformance | flag[ OpTid ] | flag[ OpTid ] | flag[ OpTid ] | flag[ OpTid ] | flag[ OpTid ] |
| Multiview | 1 | 1 | 0 | 0 | 1 |
| Monochrome | | | | | |
| Multiview | 1 | 1 | 0 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 1 | 1 | 0 | 0 | 1 |
| Monochrome | | | | | |
| 16 | | | | | |

### G.11.2.1 General Tier and Level Limits

For purposes of comparison of tier capabilities, the tier with general_tier_flag or sub_layer_tier_flag[i] equal to 0 is considered to be a lower tier than the tier with general_tier_flag or sub_layer_tier_flag[i] equal to 1.
For purposes of comparison of level capabilities, a particular level of a specific tier is considered to be a lower level than some other level of the same tier when the value of the general_level_idc or sub_layer_level_idc[i] of the particular level is less than that of the other level.
The following is specified for expressing the constraints in this subclause and H.11.2.2:
For the Multiview Main profile, the value of each of the variables CpbVclFactor, CpbNalFactor, FormatCapabilityFactor, and MinCrScaleFactor is the same as that specified in Table A.10 for the Main profile. For the Multiview Main 10 profile, the value of each of these variables is the same as that specified in Table A.10 for the Main 10 profile.
For the Multiview Monochrome profile, the value of each of the variables CpbVclFactor, CpbNalFactor, FormatCapabilityFactor, and MinCrScaleFactor is the same as that specified in Table A.10 for the Monochrome profile.
For the Multiview Monochrome 10 profile, the value of each of the variables CpbVclFactor, CpbNalFactor, FormatCapabilityFactor, and MinCrScaleFactor is the same as that specified in Table A.10 for the Monochrome 10 profile.
For the Multiview Monochrome 12 profile, the value of each of the variables CpbVclFactor, CpbNalFactor, FormatCapabilityFactor, and MinCrScaleFactor is the same as that specified in Table A.10 for the Monochrome 12 profile.
For the Multiview Monochrome 16 profile, the value of each of the variables CpbVclFactor, CpbNalFactor, FormatCapabilityFactor, and MinCrScaleFactor is the same as that specified in Table A.10 for the Monochrome 16 profile.
Let access unit n be the n-th access unit in decoding order, with the first access unit being access unit 0 (i.e. the 0-th access unit).
Let the variable fR be set as follows:
   If the bitstream or sub-layer representation is indicated to conform to the Main tier or is indicated to conform to a level that is lower than level 7.0, fR is set equal to 1÷300.
   Otherwise, fR is set equal to 1÷960.
Let the variable olsIdx be the index of the OLS.
For each layer with nuh_layer_id equal to currLayerId, let the variable layerSizeInSamplesY be derived as follows:
   layerSizeInSamplesY=pic_width_vps_in_luma_samples*pic_height_vps_in_luma_samples (G-2) where pic_width_vps_in_luma_samples and pic_height_vps_in_luma_samples are found in the vps_rep_format_idx[LayerIdxInVps[currLayerId]]-th rep_format( ) syntax structure in the VPS.
      . . . .

### 5.2 Embodiment 2

In this embodiment, “auxillary depth layers” instead of “depth layers” are defined, and the bitstream of an OLS can contain both texture layers and auxillary depth layers.

In one example, an auxillary depth layer is defined as a layer with a nuh_layer_id value equal to i such that DepthLayerFlag[i] and DependencyId[i] are both equal to 0 and AuxId[i] is equal to auxiliary depth (AUX_DEPTH).

Alternatively, an auxillary depth layer is defined as a layer with a nuh_layer_id value equal to i such that DependencyId[i] is equal to 0 and AuxId[i] is equal to AUX_DEPTH.

Alternatively, an auxillary depth layer is defined as a layer with a nuh_layer_id value equal to i such that AuxId[i] is equal to AUX_DEPTH.

Alternatively, an auxillary depth layer is defined as a layer with a nuh_layer_id value equal to i such that DepthLayerFlag[i] is equal to 1, DependencyId[i] is equal to 0, and AuxId[i] is equal to AUX_DEPTH.

### F.7.4.3.1.1 Video Parameter Set Extension Semantics

. . .
scalability_mask_flag[i] equal to 1 indicates that dimension_id syntax elements corresponding to the i-th scalability dimension in Table F.1 are present. scalability_mask_flag[i] equal to 0 indicates that dimension_id syntax elements corresponding to the i-th scalability dimension are not present.

TABLE F.1
Mapping of ScalabiltyId to scalability dimensions

| Scalability | Scalability | ScalabilityId |
|---|---|---|
| mask index | dimension | mapping |
| 0 | Texture or depth | DepthLayerFlag |
| 1 | Multiview | ViewOrderIdx |
| 2 | Spatial/quality | DependencyId |
| | scalability | |
| 3 | Auxiliary | AuxId |
| 4-15 | Reserved | |

. . .

TABLE F.2
Mapping of AuxId to the type of auxiliary pictures

| | | | SEI message describing interpretation |
|---|---|---|---|
| AuxId | Name of AuxId | Type of auxiliary pictures | of auxiliary pictures |
| 1 | AUX_ALPHA | Alpha plane | Alpha channel information |
| 2 | AUX_DEPTH | Depth picture | Depth representation information |
| 3 . . . 127 | | Reserved | |
| 128 . . . 159 | | Unspecified | |
| 160 . . . 255 | | Reserved | |

. . . .

### F.11.2 Decoder Capabilities

. . .

TABLE F.3
Specification of CompatibleProfileList

| Profile to which | Profiles that the decoder shall support |
|---|---|
| the decoder conforms | CompatibleProfileList |
| Scalable Main | Scalable Main, Main, Main Still Picture |
| Scalable Main 10 | Scalable Main 10, Main, Main Still Picture, Main 10, |
| | Scalable Main |
| Scalable Monochrome | The compatible format range extensions profiles of |
| | the Monochrome profile, and the compatible scalable |
| | format range extensions profiles of the Scalable |
| | Monochrome profile |
| Scalable Monochrome 12 | The compatible format range extensions profiles of |
| | the Monochrome 12 profile, and the compatible |
| | scalable format range extensions profiles of the |
| | Scalable Monochrome 12 profile |
| Scalable Monochrome 16 | The compatible format range extensions profiles of |
| | the Monochrome 16 profile, and the compatible |
| | scalable format range extensions profiles of the |
| | Scalable Monochrome 16 profile |
| Scalable Main 4:4:4 | Scalable Main, Main, Main Still Picture, the |
| | compatible format range extensions profiles of the |
| | Main 4:4:4 profile, and the compatible scalable |
| | format range extensions profiles of the Scalable Main |
| | 4:4:4 profile |
| Multiview Main | Multiview Main, Main, Main Still Picture |
| Multiview Main 10 | Multiview Main 10, Main, Main Still Picture, Main |
| | 10, Multiview Main |
| Multiview Monochrome | Multiview Monochrome, Monochrome |
| Multiview Monochrome 10 | Multiview Monochrome 10, Multiview Monochrome, |
| | Monochrome 10, Monochrome |
| Multiview Monochrome 12 | Multiview Monochrome 12, Multiview Monochrome |
| | 10, Multiview Monochrome, Monochrome 12, |
| | Monochrome 10, Monochrome |
| Multiview Monochrome | Multiview Monochrome 16, Multiview |
| 16 | Monochrome 12, Multiview Monochrome 10, |
| | Multiview Monochrome, Monochrome 16, |
| | Monochrome 12, Monochrome 10, Monochrome |
| 3D Main | 3D Main, Multiview Main, Main, Main Still Picture |

. . . .

### G.3 Definitions

The specifications in clause F.3 and its subclauses apply.
For the purpose of this annex, the following definitions apply in addition to the definitions in clause F.3.
auxillary depth layer: A layer with a nuh_layer_id value equal to i, such that DepthLayerFlag[i] and DependencyId[i] are both equal to 0 and AuxId[i] is equal to AUX_DEPTH.
texture layer: A layer with a nuh_layer_id value equal to i, such that DepthLayerFlag[i], DependencyId[i], and AuxId[i] are all equal to 0.
   . . . .

### G.11.1.1 Multiview Main and Multiview Main 10 Profiles

For a layer in an output operation point associated with an OLS in a bitstream, the layer being conforming to the Multiview Main or and—Multiview Main 10 profile, the following applies:
Let olsIdx be the OLS index of the OLS, the sub-bitstream subBitstream and the base layer sub-bitstream baseBitstream are derived as specified in F.11.3.
   When vps_base_layer_internal_flag is equal to 1, the base layer sub-bitstream baseBitstream shall obey the following constraints:
When the layer conforms to the Multiview Main profile, the base layer sub-bitstream baseBitstream shall be indicated to conform to the Main profile.
When the layer conforms to the Multiview Main 10 profile, the base layer sub-bitstream baseBitstream shall be indicated to conform to the Main 10 or the Main profile.
   The sub-bitstream subBitstream shall obey the following constraints:
All active VPSs shall have vps_num_rep_formats_minus1 in the range of 0 to 15, inclusive.
When the layer conforms to the Multiview Main profile, all All active SPSs for layers in subBitstream shall have chroma_format_idc equal to 1 only.
When the layer conforms to the Multiview Main 10 profile, all active SPSs for a texture layer in subBitstream shall have chroma_format_idc equal to 1 only, and all active SPSs for an auxillary depth layer in subBitstream shall have chroma_format_idc equal to 0 only.
When the layer conforms to the Multiview Main 10 profile, for a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, and AuxId[i] shall be equal to AuxId[j].
All active SPSs for layers in subBitstream shall have transform_skip_rotation_enabled_flag, transform_skip_context_enabled_flag, implicit_rdpcm_enabled_flag, explicit_rdpcm_enabled_flag, extended_precision_processing_flag, intra_smoothing_disabled_flag, high_precision_offsets_enabled_flag, persistent_rice_adaptation_enabled_flag, and cabac_bypass_alignment_enabled_flag, when present, equal to 0 only.
Ctb Log 2SizeY derived from all active SPSs for layers in subBitstream shall be in the range of 4 to 6, inclusive.
All active PPSs for layers in subBitstream shall have log 2_max_transform_skip_block_size_minus2 and chroma_qp_offset_list_enabled_flag, when present, equal to 0 only.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
When NumLayersInIdList[OlsIdxToLsIdx[olsIdx]] is equal to 2, output_layer_flag[olsIdx][j] derived according to any active VPS shall be equal to 1 for j in the range of 0 to 1, inclusive, for subBitstream.
All active VPSs shall have alt_output_layer_flag[olsIdx] equal to 0 only.
When ViewOrderIdx[i] derived according to any active VPS is equal to 1 for the layer with nuh_layer_id equal to i in subBitstream, inter_view_mv_vert_constraint_flag shall be equal to 1 in the sps_multilayer_extension( ) syntax structure in each active SPS for that layer.
When ViewOrderIdx[i] derived according to any active VPS is greater than to 0 for the layer with nuh_layer_id equal to i in subBitstream, num_ref_loc_offsets shall be equal to 0 in each active PPS for that layer.
When the layer conforms to the Multiview Main profile and ViewOrderIdx[i] derived according to any active VPS is greater than 0 for the layer with nuh_layer_id equal to i in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When the layer conforms to the Multiview Main 10 profile, for any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When the layer conforms to the Multiview Main 10 profile and there are two different layers, a texture layer and an auxillary depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the auxillary depth layer shall be less than or equal to the values of pic_width_in_luma_samples and pic_height_in_luma_samples, respectively, in each active SPS for the texture layer.
For a layer with nuh_layer_id iNuhLId equal to any value included in layerIdListTarget that was used to derive subBitstream, the value of NumRefLayers[iNuhLId], which specifies the total number of direct and indirect reference layers and is derived as specified in F.7.4.3.1, shall be less than or equal to 4.
All active SPSs for layers in subBitstream shall have sps_range_extension_flag and sps_scc_extension_flag equal to 0 only.
All active PPSs for layers in subBitstream shall have pps_range_extension_flag and pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, ViewOrderIdx[i] shall be greater than ViewOrderIdx[j] for any values of i and j among layerIdListTarget that was used to derive subBitstream such that AuxId[i] is equal to AuxId[j] and i is greater than j.
All active PPSs for in subBitstream shall have colour_mapping_enabled_flag equal to 0 only.
   When the layer conforms to the Multiview Main profile, the sub-bitstream subBitstream shall obey the following constraints:
All active SPSs for layers in subBitstream shall have bit_depth_luma_minus8 equal to 0 only.
All active SPSs for layers in subBitstream shall have bit_depth_chroma_minus8 equal to 0 only.
All active PPSs for layers in subBitstream shall have colour_mapping_enabled_flag equal to 0 only.
The tier and level constraints specified for the Multiview Main profile in G.11.2 shall be fulfilled.
   When the layer conforms to the Multiview Main 10 profile, the sub-bitstream subBitstream shall obey the following constraints:
All active SPSs for layers—a texture layer in subBitstream shall have bit_depth_luma_minus8 in the range of 0 to 2, inclusive, and all active SPSs for an auxillary depth layer in subBitstream shall have bit_depth_luma_minus8 in the range of 0 to 8, inclusive.
All active SPSs for layers a texture layer in subBitstream shall have bit_depth_chroma_minus8 in the range of 0 to 2, inclusive, and all active SPSs for an auxillary depth layer in subBitstream shall have bit_depth_chroma_minus8 in the range of 0 to 8, inclusive.
For a layer layerA with nuh_layer_id equal to i in subBitstream and another layer layerB with nuh_layer_id equal to j, when layerB is a reference layer of layerA, the value of bit_depth_luma_minus8 for layerA and the value of bit_depth_luma_minus8 for layerB shall be identical, and the value of bit_depth_chroma_minus8 for layerA and the value of bit_depth_chroma_minus8 for layerB shall be identical.
The tier and level constraints specified for the Multiview Main 10 profile in G.11.2 shall be fulfilled.
   In the remainder of this subclause and G.11.2.1, all syntax elements in the profile_tier_level( ) syntax structure refer to those in the profile_tier_level( ) syntax structure associated with the layer.
   . . . .

### G.11.1.2 Multiview Format Range Extensions Profiles

The following profiles, collectively referred to as the multiview format range extensions profiles, are specified in this subclause:
the Multiview Monochrome, Multiview Monochrome 10, and—Multiview Monochrome 12, and Multiview Monochrome 16 profiles.
   For a layer in an output operation point associated with an OLS in a bitstream, the layer being conforming to the Multiview Monochrome, Multiview Monochrome 10, or—Multiview Monochrome 12, or Multiview Monochrome 16 profile, the following applies:
Let olsIdx be the OLS index of the OLS, the sub-bitstream subBitstream and the base layer sub-bitstream baseBitstream are-is derived as specified in F.11.3.
   When vps_base_layer_internal_flag is equal to 1, the base layer sub-bitstream baseBitstream shall obey the following constraints:
When the layer conforms to the Multiview Monochrome, the base layer sub-bitstream baseBitstream shall be indicated to conform to the Monochrome profile.
When the layer conforms to the Multiview Monochrome 10, the base layer sub-bitstream baseBitstream shall be indicated to conform to the Monochrome profile or the Monochrome 10 profile.
When the layer conforms to the Multiview Monochrome 12, the base layer sub-bitstream baseBitstream shall be indicated to conform to the Monochrome profile, the Monochrome 10 profile, or a format range extensions profile.
   The sub-bitstream subBitstream shall obey the following constraints:
All active VPSs shall have vps_num_rep_formats_minus1 in the range of 0 to 15, inclusive.
All active SPSs for layers a layer conforming to the Multiview Monochrome, Multiview Monochrome 10, Multiview Monochrome 12 or Multiview Monochrome 16 profile in subBitstream shall have chroma_format_idc equal to 1-0 only.
All active SPSs for layers in subBitstream shall have separate_colour_plane_flag, cabac_bypass_alignment_enabled_flag, when present, equal to 0 only.
Ctb Log 2SizeY derived from all active SPSs for layers in subBitstream shall be in the range of 4 to 6, inclusive.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
The constraints specified in Table H.3, in which entries marked with “−” indicate that the table entry does not impose a profile-specific constraint on the corresponding syntax element, shall apply for all active SPSs and PPSs for layers in subBitstream.
NOTE For some syntax elements with table entries marked with “−”, a constraint may be imposed indirectly—e.g. by semantics constraints that are imposed elsewhere in this document when other specified constraints are fulfilled.
For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, the value of bit_depth_luma_minus8 for layerA and the value of bit_depth_luma_minus8 for layerB shall be identical, the value of bit_depth_chroma_minus8 for layerA and the value of bit_depth_chroma_minus8 for layerB shall be identical, and AuxId[i] shall be equal to AuxId[j].
For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When there are two different layers, a texture layer and an auxillary depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the auxillary depth layer shall be less than or equal to the values of pic_width_in_luma_samples and pic_height_in_luma_samples, respectively, in each active SPS for the texture layer.
All active SPSs for layers in subBitstream shall have sps_scc_extension_flag equal to 0 only.
All active PPSs for layers in subBitstream shall have pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, DependencyId[i] shall be greater than DependencyId[j] for any values of i and j among layerIdListTarget that was used to derive subBitstream such that AuxId[i] is equal to AuxId[j] and i is greater than j.
The tier and level constraints specified for the Multiview Monochrome, Multiview Monochrome 10, and Multiview Monochrome 12 profiles in G.11.2, as applicable, shall be fulfilled.

TABLE G.3
Allowed values for syntax elements in the multiview format range extensions profiles

| | | | transform_skip_rotation_enabled_flag, |
|---|---|---|---|
| | | | transform_skip_context_enabled_flag, |
| | | | implicit_rdpcm_enabled_flag, |
| | | | explicit_rdpcm_enabled_flag, |
| Profile for which | | bit_depth_luma_minus8 and | intra_smoothing_disabled_flag, |
| constraint is specified | chroma_format_idc | bit_depth_chroma_minus8 | [symbol] |
| Multiview Monochrome | 0 | 0 | 0 |
| Multiview Monochrome 10 | 0 | 0 . . . 2 | 0 |
| Multiview Monochrome 12 | 0 | 0 . . . 4 | 0 |
| Multiview Monochrome 16 | 0 | 0 . . . 8 | 0 |

| Profile for which | | |
|---|---|---|
| constraint is specified | extended_precision_processing_flag | chroma_qp_offset_list_enabled_flag |
| Multiview Monochrome | 0 | 0 |
| Multiview Monochrome 10 | 0 | 0 |
| Multiview Monochrome 12 | 0 | 0 |
| Multiview Monochrome 16 | 0 | 0 |

[symbol]

indicates data missing or illegible when filed

In the remainder of this subclause and H.11.2.1, all syntax elements in the profile_tier_level( ) syntax structure refer to those in the profile_tier_level( ) syntax structure associated with the layer.
Conformance of a layer in an output operation point associated with an OLS in a bitstream for the multiview format range extensions profiles is indicated as follows:
If OpTid of the output operation point is equal to vps_max_sub_layer_minus1, the conformance is indicated by general_profile_idc being equal to 10 or general_profile_compatibility_flag[10] being equal to 1, with the additional indications specified in Table H.4 for the general constraint flags.
Otherwise (OpTid of the output operation point is less than vps_max_sub_layer_minus1), the conformance is indicated by sub_layer_profile_idc[OpTid] being equal to 10 or sub_layer_profile_compatibility_flag[OpTid][10] being equal to 1, with the additional indications specified in Table H.4 for the flags associated with the index OpTid.
   All other combinations of general_max_14bit_constraint_flag, general_max_12bit_constraint_flag, general_max_10bit_constraint_flag, general_max_8bit_constraint_flag, general_max_422chroma_constraint_flag, general_max_420chroma_constraint_flag, general_max_monochrome_constraint_flag, general_intra_constraint_flag, general_one_picture_only_constraint_flag, and general_lower_bit_rate_constraint_flag with general_profile_idc equal to 10 or general_profile_compatibility_flag[10] equal to 1 are reserved for future use by ITU-T|ISO/IEC. All other combinations of sub_layer_max_14bit_constraint_flag[OpTid], sub_layer_max_12bit_constraint_flag[OpTid], sub_layer_max_10bit_constraint_flag[OpTid], sub_layer_max_8bit_constraint_flag[OpTid], sub_layer_max_422chroma_constraint_flag[OpTid], sub_layer_max_420chroma_constraint_flag[OpTid], sub_layer_max_monochrome_constraint_flag[OpTid], sub_layer_intra_constraint_flag[OpTid], sub_layer_one_picture_only_constraint_flag[OpTid], and sub_layer_lower_bit_rate_constraint_flag[OpTid] with sub_layer_profile_idc[OpTid] equal to 10 or sub_layer_profile_compatibility_flag[OpTid][10] equal to 1 are reserved for future use by ITU-T|ISO/IEC. Such combinations shall not be present in bitstreams conforming to this document. However, decoders conforming to the multiview format range extensions profiles shall allow other combinations as specified below in this clause to occur in the bitstream.

TABLE G.4
Bitstream indications for conformance to multiview range extensions profiles

| | general_{—} | general_{—} | general_{—} | general_{—} | general_{—} |
|---|---|---|---|---|---|
| | max_14bit_{—} | max_12bit_{—} | max_10bit_{—} | max_8bit_{—} | max_422chroma_{—} |
| Profile for | constraint_{—} | constraint_{—} | constraint_{—} | constraint_{—} | constraint_{—} |
| which the | flag or | flag or | flag or | flag or | flag or |
| bitstream | sub_layer_{—} | sub_layer_{—} | sub_layer_{—} | sub_layer_{—} | sub_layer_{—} |
| indicates | max_14bit_{—} | max_12bit_{—} | max_10bit_{—} | max_8bit_{—} | max_422chroma_{—} |
| conformance | constraint_{—} | constraint_{—} | constraint_{—} | constraint_{—} | constraint_{—} |
| Multiview | 1 | 1 | 1 | 1 | 1 |
| Monochrome | | | | | |
| Multiview | 1 | 1 | 1 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 0 | 0 | 0 | 0 | 1 |
| Monochrome | | | | | |
| 16 | | | | | |

| | | | | general_{—} | |
|---|---|---|---|---|---|
| | | | | one_{—} | |
| | general_{—} | | | picture_{—} | general_{—} |
| | max_{—} | | general_{—} | only_{—} | lower_{—} |
| | 420chroma_{—} | | intra_{—} | constraint_{—} | bit_rate_{—} |
| | constraint_{—} | | constraint_{—} | flag or | constraint_{—} |
| Profile for | flag or | general_{—} | flag or | sub_layer_{—} | flag or |
| which the | sub_layer_{—} | max_{—} | sub_layer_{—} | one_{—} | sub_layer_{—} |
| bitstream | max_{—} | monochrome_{—} | intra_{—} | picture_{—} | lower_{—} |
| indicates | 420chroma_{—} | constraint_{—} | constraint_{—} | only_{—} | bit_rate_{—} |
| conformance | constraint_{—} | flag or | flag[ OpTid ] | constraint_{—} | constraint |
| Multiview | 1 | 1 | 0 | 0 | 1 |
| Monochrome | | | | | |
| Multiview | 1 | 1 | 0 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 1 | 1 | 0 | 0 | 1 |
| Monochrome | | | | | |
| 16 | | | | | |

### G.11.2.1 General Tier and Level Limits

For purposes of comparison of tier capabilities, the tier with general_tier_flag or sub_layer_tier_flag[i] equal to 0 is considered to be a lower tier than the tier with general_tier_flag or sub_layer_tier_flag[i] equal to 1.
For purposes of comparison of level capabilities, a particular level of a specific tier is considered to be a lower level than some other level of the same tier when the value of the general_level_idc or sub_layer_level_idc[i] of the particular level is less than that of the other level.
The following is specified for expressing the constraints in this subclause and H.11.2.2:
For the Multiview Main profile, the value of each of the variables CpbVclFactor, CpbNalFactor, FormatCapabilityFactor, and MinCrScaleFactor is the same as that specified in Table A.10 for the Main profile. For the Multiview Main 10 profile, the value of each of these variables is the same as that specified in Table A.10 for the Main 10 profile.
For the Multiview Monochrome profile, the value of each of the variables CpbVclFactor, CpbNalFactor, FormatCapabilityFactor, and MinCrScaleFactor is the same as that specified in Table A.10 for the Monochrome profile.
For the Multiview Monochrome 10 profile, the value of each of the variables CpbVclFactor, CpbNalFactor, FormatCapabilityFactor, and MinCrScaleFactor is the same as that specified in Table A.10 for the Monochrome 10 profile.
For the Multiview Monochrome 12 profile, the value of each of the variables CpbVclFactor, CpbNalFactor, FormatCapabilityFactor, and MinCrScaleFactor is the same as that specified in Table A.10 for the Monochrome 12 profile.
For the Multiview Monochrome 16 profile, the value of each of the variables CpbVclFactor, CpbNalFactor, FormatCapabilityFactor, and MinCrScaleFactor is the same as that specified in Table A.10 for the Monochrome 16 profile.
Let access unit n be the n-th access unit in decoding order, with the first access unit being access unit 0 (i.e. the 0-th access unit).
Let the variable fR be set as follows:
   If the bitstream or sub-layer representation is indicated to conform to the Main tier or is indicated to conform to a level that is lower than level 7.0, fR is set equal to 1÷300.
   Otherwise, fR is set equal to 1÷960.
Let the variable olsIdx be the index of the OLS.
For each layer with nuh_layer_id equal to currLayerId, let the variable layerSizeInSamplesY be derived as follows:
layerSizeInSamplesY=pic_width_vps_in_luma_samples*pic_height_vps_in_luma_samples (G-2) where pic_width_vps_in_luma_samples and pic_height_vps_in_luma_samples are found in the vps_rep_format_idx[LayerIdxInVps[currLayerId]]-th rep_format( ) syntax structure in the VPS.
   . . . .

### 5.3 Embodiment 3

Same as in the second embodiment, in this embodiment, “auxillary depth layers” instead of “depth layers” are defined, and the bitstream of an OLS can contain both texture layers and auxillary depth layers. The key difference compared to the second embodiment is that in this embodiment the same (the bitstream of an OLS can contain both texture layers and auxillary depth layers) also applies for the existing Multiview Main profile.

In one example, an auxillary depth layer is defined as a layer with a nuh_layer_id value equal to i such that DepthLayerFlag[i] and DependencyId[i] are both equal to 0 and AuxId[i] is equal to AUX_DEPTH.

Alternatively, an auxillary depth layer is defined as a layer with a nuh_layer_id value equal to i such that DependencyId[i] is equal to 0 and AuxId[i] is equal to AUX_DEPTH.

Alternatively, an auxillary depth layer is defined as a layer with a nuh_layer_id value equal to i such that AuxId[i] is equal to AUX_DEPTH.

Alternatively, an auxillary depth layer is defined as a layer with a nuh_layer_id value equal to i such that DepthLayerFlag[i] is equal to 1, DependencyId[i] is equal to 0, and AuxId[i] is equal to AUX_DEPTH.

### F.7.4.3.1.1 Video Parameter Set Extension Semantics

. . .
scalability_mask_flag[i] equal to 1 indicates that dimension_id syntax elements corresponding to the i-th scalability dimension in Table F.1 are present. scalability_mask_flag[i] equal to 0 indicates that dimension_id syntax elements corresponding to the i-th scalability dimension are not present.

TABLE F.1
Mapping of ScalabiltyId to scalability dimensions

| Scalability | Scalability | ScalabilityId |
|---|---|---|
| mask index | dimension | mapping |
| 0 | Texture or depth | DepthLayerFlag |
| 1 | Multiview | ViewOrderIdx |
| 2 | Spatial/quality | DependencyId |
| | scalability | |
| 3 | Auxiliary | AuxId |
| 4-15 | Reserved | |

. . .

TABLE F.2
Mapping of AuxId to the type of auxiliary pictures

| | | | SEI message describing interpretation |
|---|---|---|---|
| AuxId | Name of AuxId | Type of auxiliary pictures | of auxiliary pictures |
| 1 | AUX_ALPHA | Alpha plane | Alpha channel information |
| 2 | AUX_DEPTH | Depth picture | Depth representation information |
| 3 . . . 127 | | Reserved | |
| 128 . . . 159 | | Unspecified | |
| 160 . . . 255 | | Reserved | |

. . . .

### F.11.2 Decoder Capabilities

. . .

TABLE F.3
Specification of CompatibleProfileList

| Profile to which | Profiles that the decoder shall support |
|---|---|
| the decoder conforms | CompatibleProfileList |
| Scalable Main | Scalable Main, Main, Main Still Picture |
| Scalable Main 10 | Scalable Main 10, Main, Main Still Picture, Main 10, |
| | Scalable Main |
| Scalable Monochrome | The compatible format range extensions profiles of |
| | the Monochrome profile, and the compatible scalable |
| | format range extensions profiles of the Scalable |
| | Monochrome profile |
| Scalable Monochrome 12 | The compatible format range extensions profiles of |
| | the Monochrome 12 profile, and the compatible |
| | scalable format range extensions profiles of the |
| | Scalable Monochrome 12 profile |
| Scalable Monochrome 16 | The compatible format range extensions profiles of |
| | the Monochrome 16 profile, and the compatible |
| | scalable format range extensions profiles of the |
| | Scalable Monochrome 16 profile |
| Scalable Main 4:4:4 | Scalable Main, Main, Main Still Picture, the |
| | compatible format range extensions profiles of the |
| | Main 4:4:4 profile, and the compatible scalable |
| | format range extensions profiles of the Scalable Main |
| | 4:4:4 profile |
| Multiview Main | Multiview Main, Main, Main Still Picture |
| Multiview Main 10 | Multiview Main 10, Main, Main Still Picture, Main |
| | 10, Multiview Main |
| Multiview Monochrome | Multiview Monochrome, Monochrome |
| Multiview Monochrome 10 | Multiview Monochrome 10, Multiview Monochrome, |
| | Monochrome 10, Monochrome |
| Multiview Monochrome 12 | Multiview Monochrome 12, Multiview Monochrome |
| | 10, Multiview Monochrome, Monochrome 12, |
| | Monochrome 10, Monochrome |
| Multiview Monochrome | Multiview Monochrome 16, Multiview |
| 16 | Monochrome 12, Multiview Monochrome 10, |
| | Multiview Monochrome, Monochrome 16, |
| | Monochrome 12, Monochrome 10, Monochrome |
| 3D Main | 3D Main, Multiview Main, Main, Main Still Picture |

. . . .

### G.3 Definitions

The specifications in clause F.3 and its subclauses apply.
For the purpose of this annex, the following definitions apply in addition to the definitions in clause F.3.
auxillary depth layer: A layer with a nuh_layer_id value equal to i, such that DepthLayerFlag[i] and DependencyId[i] are both equal to 0 and AuxId[i] is equal to AUX_DEPTH.
texture layer: A layer with a nuh_layer_id value equal to i, such that DepthLayerFlag[i], DependencyId[i], and AuxId[i] are all equal to 0.
   . . . .

### G.11.1.1 Multiview Main and Multiview Main 10 Profiles

For a layer in an output operation point associated with an OLS in a bitstream, the layer being conforming to the Multiview Main or and Multiview Main 10 profile, the following applies:
Let olsIdx be the OLS index of the OLS, the sub-bitstream subBitstream and the base layer sub-bitstream baseBitstream are derived as specified in F.11.3.
   When vps_base_layer_internal_flag is equal to 1, the base layer sub-bitstream baseBitstream shall obey the following constraints:
When the layer conforms to the Multiview Main profile, the base layer sub-bitstream baseBitstream shall be indicated to conform to the Main profile.
When the layer conforms to the Multiview Main 10 profile, the base layer sub-bitstream baseBitstream shall be indicated to conform to the Main 10 or the Main profile.
   The sub-bitstream subBitstream shall obey the following constraints:
All active VPSs shall have vps_num_rep_formats_minus1 in the range of 0 to 15, inclusive.
All active SPSs for a texture layer in subBitstream shall have chroma_format_idc equal to 1 only, and all active SPSs for an auxillary depth layer in subBitstream shall have chroma_format_idc equal to 0 only.
For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, and AuxId[i] shall be equal to AuxId[j].
All active SPSs for layers in subBitstream shall have transform_skip_rotation_enabled_flag, transform_skip_context_enabled_flag, implicit_rdpcm_enabled_flag, explicit_rdpcm_enabled_flag, extended_precision_processing_flag, intra_smoothing_disabled_flag, high_precision_offsets_enabled_flag, persistent_rice_adaptation_enabled_flag, and cabac_bypass_alignment_enabled_flag, when present, equal to 0 only.
Ctb Log 2SizeY derived from all active SPSs for layers in subBitstream shall be in the range of 4 to 6, inclusive.
All active PPSs for layers in subBitstream shall have log 2_max_transform_skip_block_size_minus2 and chroma_qp_offset_list_enabled_flag, when present, equal to 0 only.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
When NumLayersInIdList[OlsIdxToLsIdx[olsIdx]] is equal to 2, output_layer_flag[olsIdx][j] derived according to any active VPS shall be equal to 1 for j in the range of 0 to 1, inclusive, for subBitstream.
All active VPSs shall have alt_output_layer_flag[olsIdx] equal to 0 only.
When ViewOrderIdx[i] derived according to any active VPS is equal to 1 for the layer with nuh_layer_id equal to i in subBitstream, inter_view_mv_vert_constraint_flag shall be equal to 1 in the sps_multilayer_extension( ) syntax structure in each active SPS for that layer.
When ViewOrderIdx[i] derived according to any active VPS is greater than to 0 for the layer with nuh_layer_id equal to i in subBitstream, num_ref_loc_offsets shall be equal to 0 in each active PPS for that layer.
When ViewOrderIdx[i] derived according to any active VPS is greater than 0 for the layer with nuh_layer_id equal to i in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When there are two different layers, a texture layer and an auxillary depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the auxillary depth layer shall be less than or equal to the values of pic_width_in_luma_samples and pic_height_in_luma_samples, respectively, in each active SPS for the texture layer.
For a layer with nuh_layer_id iNuhLId equal to any value included in layerIdListTarget that was used to derive subBitstream, the value of NumRefLayers[iNuhLId], which specifies the total number of direct and indirect reference layers and is derived as specified in F.7.4.3.1, shall be less than or equal to 4.
All active SPSs for layers in subBitstream shall have sps_range_extension_flag and sps_scc_extension_flag equal to 0 only.
All active PPSs for layers in subBitstream shall have pps_range_extension_flag and pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, ViewOrderIdx[i] shall be greater than ViewOrderIdx[j] for any values of i and j among layerIdListTarget that was used to derive subBitstream such that AuxId[i] is equal to AuxId[j] and i is greater than j.
All active PPSs for in subBitstream shall have colour_mapping_enabled_flag equal to 0 only.
   When the layer conforms to the Multiview Main profile, the sub-bitstream subBitstream shall obey the following constraints:
All active SPSs for layers a texture layer in subBitstream shall have bit_depth_luma_minus8 equal to 0 only, and all active SPSs for an auxillary depth layer in subBitstream shall have bit_depth_luma_minus8 in the range of 0 to 8, inclusive.
All active SPSs for layers a texture layer in subBitstream shall have bit_depth_chroma_minus8 equal to 0 only, and all active SPSs for an auxillary depth layer in subBitstream shall have bit_depth_chroma_minus8 in the range of 0 to 8, inclusive.
All active PPSs for in subBitstream shall have colour_mapping_enabled_flag equal to 0 only.
The tier and level constraints specified for the Multiview Main profile in G.11.2 shall be fulfilled.
   When the layer conforms to the Multiview Main 10 profile, the sub-bitstream subBitstream shall obey the following constraints:
All active SPSs for layers a texture layer in subBitstream shall have bit_depth_luma_minus8 in the range of 0 to 2, inclusive, and all active SPSs for an auxillary depth layer in subBitstream shall have bit_depth_luma_minus8 in the range of 0 to 8, inclusive.
All active SPSs for layers a texture layer in subBitstream shall have bit_depth_chroma_minus8 in the range of 0 to 2, inclusive, and all active SPSs for an auxillary depth layer in subBitstream shall have bit_depth_chroma_minus8 in the range of 0 to 8, inclusive.
For a layer layerA with nuh_layer_id equal to i in subBitstream and another layer layerB with nuh_layer_id equal to j, when layerB is a reference layer of layerA, the value of bit_depth_luma_minus8 for layerA and the value of bit_depth_luma_minus8 for layerB shall be identical, and the value of bit_depth_chroma_minus8 for layerA and the value of bit_depth_chroma_minus8 for layerB shall be identical.
The tier and level constraints specified for the Multiview Main 10 profile in G.11.2 shall be fulfilled.
   In the remainder of this subclause and G.11.2.1, all syntax elements in the profile_tier_level( ) syntax structure refer to those in the profile_tier_level( ) syntax structure associated with the layer.
   . . . .

### G.11.1.2 Multiview Format Range Extensions Profiles

The following profiles, collectively referred to as the multiview format range extensions profiles, are specified in this subclause:
the Multiview Monochrome, Multiview Monochrome 10, and—Multiview Monochrome 12, and Multiview Monochrome 16 profiles.
   For a layer in an output operation point associated with an OLS in a bitstream, the layer being conforming to the Multiview Monochrome, Multiview Monochrome 10, or—Multiview Monochrome 12, or Multiview Monochrome 16 profile, the following applies:
Let olsIdx be the OLS index of the OLS, the sub-bitstream subBitstream and the base layer sub-bitstream baseBitstream are-is derived as specified in F.11.3.
   When vps_base_layer_internal_flag is equal to 1, the base layer sub-bitstream baseBitstream shall obey the following constraints:
When the layer conforms to the Multiview Monochrome, the base layer sub-bitstream baseBitstream shall be indicated to conform to the Monochrome profile.
When the layer conforms to the Multiview Monochrome 10, the base layer sub-bitstream baseBitstream shall be indicated to conform to the Monochrome profile or the Monochrome 10 profile.
When the layer conforms to the Multiview Monochrome 12, the base layer sub-bitstream baseBitstream shall be indicated to conform to the Monochrome profile, the Monochrome 10 profile, or a format range extensions profile.
   The sub-bitstream subBitstream shall obey the following constraints:
All active VPSs shall have vps_num_rep_formats_minus1 in the range of 0 to 15, inclusive.
All active SPSs for layers a layer conforming to the Multiview Monochrome, Multiview Monochrome 10, Multiview Monochrome 12 or Multiview Monochrome 16 profile in subBitstream shall have chroma_format_idc equal to 10 only.
All active SPSs for layers in subBitstream shall have separate_colour_plane_flag, cabac_bypass_alignment_enabled_flag, when present, equal to 0 only.
Ctb Log 2SizeY derived from all active SPSs for layers in subBitstream shall be in the range of 4 to 6, inclusive.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
The constraints specified in Table H.3, in which entries marked with “−” indicate that the table entry does not impose a profile-specific constraint on the corresponding syntax element, shall apply for all active SPSs and PPSs for layers in subBitstream.
NOTE For some syntax elements with table entries marked with “−”, a constraint may be imposed indirectly—e.g. by semantics constraints that are imposed elsewhere in this document when other specified constraints are fulfilled.
For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, the value of bit_depth_luma_minus8 for layerA and the value of bit_depth_luma_minus8 for layerB shall be identical, the value of bit_depth_chroma_minus8 for layerA and the value of bit_depth_chroma_minus8 for layerB shall be identical, and AuxId[i] shall be equal to AuxId[j].
For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When there are two different layers, a texture layer and an auxillary depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the auxillary depth layer shall be less than or equal to the values of pic_width_in_luma_samples and pic_height_in_luma_samples, respectively, in each active SPS for the texture layer.
All active SPSs for layers in subBitstream shall have sps_scc_extension_flag equal to 0 only.
All active PPSs for layers in subBitstream shall have pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, DependencyId[i] shall be greater than DependencyId[j] for any values of i and j among layerIdListTarget that was used to derive subBitstream such that AuxId[i] is equal to AuxId[j] and i is greater than j.
The tier and level constraints specified for the Multiview Monochrome, Multiview Monochrome 10, and Multiview Monochrome 12 profiles in G.11.2, as applicable, shall be fulfilled.

TABLE G.3
Allowed values for syntax elements in the multiview format range extensions profiles

| | | | transform_skip_rotation_enabled_flag, |
|---|---|---|---|
| | | | transform_skip_context_enabled_flag, |
| | | | implicit_rdpcm_enabled_flag, |
| | | | explicit_rdpcm_enabled_flag, |
| Profile for which | | bit_depth_luma_minus8 and | intra_smoothing_disabled_flag, |
| constraint is specified | chroma_format_idc | bit_depth_chroma_minus8 | [symbol] |
| Multiview Monochrome | 0 | 0 | 0 |
| Multiview Monochrome 10 | 0 | 0 . . . 2 | 0 |
| Multiview Monochrome 12 | 0 | 0 . . . 4 | 0 |
| Multiview Monochrome 16 | 0 | 0 . . . 8 | 0 |

| Profile for which | | |
|---|---|---|
| constraint is specified | extended_precision_processing_flag | chroma_qp_offset_list_enabled_flag |
| Multiview Monochrome | 0 | 0 |
| Multiview Monochrome 10 | 0 | 0 |
| Multiview Monochrome 12 | 0 | 0 |
| Multiview Monochrome 16 | 0 | 0 |

[symbol]

indicates data missing or illegible when filed

In the remainder of this subclause and H.11.2.1, all syntax elements in the profile_tier_level( ) syntax structure refer to those in the profile_tier_level( ) syntax structure associated with the layer.
Conformance of a layer in an output operation point associated with an OLS in a bitstream for the multiview format range extensions profiles is indicated as follows:
If OpTid of the output operation point is equal to vps_max_sub_layer_minus1, the conformance is indicated by general_profile_idc being equal to 10 or general_profile_compatibility_flag[10] being equal to 1, with the additional indications specified in Table H.4 for the general constraint flags.
Otherwise (OpTid of the output operation point is less than vps_max_sub_layer_minus1), the conformance is indicated by sub_layer_profile_idc[OpTid] being equal to 10 or sub_layer_profile_compatibility_flag[OpTid][10] being equal to 1, with the additional indications specified in Table H.4 for the flags associated with the index OpTid.
   All other combinations of general_max_14bit_constraint_flag, general_max_12bit_constraint_flag, general_max_10bit_constraint_flag, general_max_8bit_constraint_flag, general_max_422chroma_constraint_flag, general_max_420chroma_constraint_flag, general_max_monochrome_constraint_flag, general_intra_constraint_flag, general_one_picture_only_constraint_flag, and general_lower_bit_rate_constraint_flag with general_profile_idc equal to 10 or general_profile_compatibility_flag[10] equal to 1 are reserved for future use by ITU-T|ISO/IEC. All other combinations of sub_layer_max_14bit_constraint_flag[OpTid], sub_layer_max_12bit_constraint_flag[OpTid], sub_layer_max_422chroma_constraint_flag[OpTid], sub_layer_max_420chroma_constraint_flag[OpTid], sub_layer_max_monochrome_constraint_flag[OpTid], sub_layer_intra_constraint_flag[OpTid], sub_layer_one_picture_only_constraint_flag[OpTid], and sub_layer_lower_bit_rate_constraint_flag[OpTid] with sub_layer_profile_idc[OpTid] equal to 10 or sub_layer_profile_compatibility_flag[OpTid][10] equal to 1 are reserved for future use by ITU-T|ISO/IEC. Such combinations shall not be present in bitstreams conforming to this document. However, decoders conforming to the multiview format range extensions profiles shall allow other combinations as specified below in this clause to occur in the bitstream.

TABLE G.4
Bitstream indications for conformance to multiview range extensions profiles

| | general_{—} | general_{—} | general_{—} | general_{—} | general_{—} |
|---|---|---|---|---|---|
| | max_14bit_{—} | max_12bit_{—} | max_10bit_{—} | max_8bit_{—} | max_422chroma_{—} |
| Profile for | constraint_{—} | constraint_{—} | constraint_{—} | constraint_{—} | constraint_{—} |
| which the | flag or | flag or | flag or | flag or | flag or |
| bitstream | sub_layer_{—} | sub_layer_{—} | sub_layer_{—} | sub_layer_{—} | sub_layer_{—} |
| indicates | max_14bit_{—} | max_12bit_{—} | max_10bit_{—} | max_8bit_{—} | max_422chroma_{—} |
| conformance | constraint_{—} | constraint_{—} | constraint_{—} | constraint_{—} | constraint_{—} |
| Multiview | 1 | 1 | 1 | 1 | 1 |
| Monochrome | | | | | |
| Multiview | 1 | 1 | 1 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 0 | 0 | 0 | 0 | 1 |
| Monochrome | | | | | |
| 16 | | | | | |

| | | | | general_{—} | |
|---|---|---|---|---|---|
| | | | | one_{—} | |
| | general_{—} | | | picture_{—} | general_{—} |
| | max_{—} | | general_{—} | only_{—} | lower_{—} |
| | 420chroma_{—} | | intra_{—} | constraint_{—} | bit_rate_{—} |
| | constraint_{—} | | constraint_{—} | flag or | constraint_{—} |
| Profile for | flag or | general_{—} | flag or | sub_layer_{—} | flag or |
| which the | sub_layer_{—} | max_{—} | sub_layer_{—} | one_{—} | sub_layer_{—} |
| bitstream | max_{—} | monochrome_{—} | intra_{—} | picture_{—} | lower_{—} |
| indicates | 420chroma_{—} | constraint_{—} | constraint_{—} | only_{—} | bit_rate_{—} |
| conformance | constraint_{—} | flag or | flag[ OpTid ] | constraint_{—} | constraint |
| Multiview | 1 | 1 | 0 | 0 | 1 |
| Monochrome | | | | | |
| Multiview | 1 | 1 | 0 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 1 | 1 | 0 | 0 | 1 |
| Monochrome | | | | | |
| 16 | | | | | |

### G.11.2.1 General Tier and Level Limits

For purposes of comparison of tier capabilities, the tier with general_tier_flag or sub_layer_tier_flag[i] equal to 0 is considered to be a lower tier than the tier with general_tier_flag or sub_layer_tier_flag[i] equal to 1.
For purposes of comparison of level capabilities, a particular level of a specific tier is considered to be a lower level than some other level of the same tier when the value of the general_level_idc or sub_layer_level_idc[i] of the particular level is less than that of the other level.
The following is specified for expressing the constraints in this subclause and H.11.2.2:
For the Multiview Main profile, the value of each of the variables CpbVclFactor, CpbNalFactor, FormatCapabilityFactor, and MinCrScaleFactor is the same as that specified in Table A.10 for the Main profile. For the Multiview Main 10 profile, the value of each of these variables is the same as that specified in Table A.10 for the Main 10 profile.
For the Multiview Monochrome profile, the value of each of the variables CpbVclFactor, CpbNalFactor, FormatCapabilityFactor, and MinCrScaleFactor is the same as that specified in Table A.10 for the Monochrome profile.
For the Multiview Monochrome 10 profile, the value of each of the variables CpbVclFactor, CpbNalFactor, FormatCapabilityFactor, and MinCrScaleFactor is the same as that specified in Table A.10 for the Monochrome 10 profile.
For the Multiview Monochrome 12 profile, the value of each of the variables CpbVclFactor, CpbNalFactor, FormatCapabilityFactor, and MinCrScaleFactor is the same as that specified in Table A.10 for the Monochrome 12 profile.
For the Multiview Monochrome 16 profile, the value of each of the variables CpbVclFactor, CpbNalFactor, FormatCapabilityFactor, and MinCrScaleFactor is the same as that specified in Table A.10 for the Monochrome 16 profile.
Let access unit n be the n-th access unit in decoding order, with the first access unit being access unit 0 (i.e. the 0-th access unit).
Let the variable fR be set as follows:
   If the bitstream or sub-layer representation is indicated to conform to the Main tier or is indicated to conform to a level that is lower than level 7.0, fR is set equal to 1÷300.
   Otherwise, fR is set equal to 1÷960.
Let the variable olsIdx be the index of the OLS.
For each layer with nuh_layer_id equal to currLayerId, let the variable layerSizeInSamplesY be derived as follows:
layerSizeInSamplesY=pic_width_vps_in_luma_samples*pic_height_vps_in_luma_samples (G-2) where pic_width_vps_in_luma_samples and pic_height_vps_in_luma_samples are found in the vps_rep_format_idx[LayerIdxInVps[currLayerId]]-th rep_format( ) syntax structure in the VPS.
   . . . .

### 5.4 Embodiment 4

In this embodiment, changes are not indicated.

### F.7.4.3.1.1 Video Parameter Set Extension Semantics

. . .
scalability_mask_flag[i] equal to 1 indicates that dimension_id syntax elements corresponding to the i-th scalability dimension in Table F.1 are present. scalability_mask_flag[i] equal to 0 indicates that dimension_id syntax elements corresponding to the i-th scalability dimension are not present.

TABLE F.1
Mapping of ScalabiltyId to scalability dimensions

| Scalability | Scalability | ScalabilityId |
|---|---|---|
| mask index | dimension | mapping |
| 0 | Texture or depth | DepthLayerFlag |
| 1 | Multiview | ViewOrderIdx |
| 2 | Spatial/quality | DependencyId |
| | scalability | |
| 3 | Auxiliary | AuxId |
| 4-15 | Reserved | |

. . .

TABLE F.2
Mapping of AuxId to the type of auxiliary pictures

| | | | SEI message describing interpretation |
|---|---|---|---|
| AuxId | Name of AuxId | Type of auxiliary pictures | of auxiliary pictures |
| 1 | AUX_ALPHA | Alpha plane | Alpha channel information |
| 2 | AUX_DEPTH | Depth picture | Depth representation information |
| 3 . . . 127 | | Reserved | |
| 128 . . . 159 | | Unspecified | |
| 160 . . . 255 | | Reserved | |

. . . .

### F.11.2 Decoder Capabilities

. . .

TABLE F.3
Specification of CompatibleProfileList

| Profile to which | Profiles that the decoder shall support |
|---|---|
| the decoder conforms | CompatibleProfileList |
| Scalable Main | Scalable Main, Main, Main Still Picture |
| Scalable Main 10 | Scalable Main 10, Main, Main Still Picture, Main 10, |
| | Scalable Main |
| Scalable Monochrome | The compatible format range extensions profiles of |
| | the Monochrome profile, and the compatible scalable |
| | format range extensions profiles of the Scalable |
| | Monochrome profile |
| Scalable Monochrome 12 | The compatible format range extensions profiles of |
| | the Monochrome 12 profile, and the compatible |
| | scalable format range extensions profiles of the |
| | Scalable Monochrome 12 profile |
| Scalable Monochrome 16 | The compatible format range extensions profiles of |
| | the Monochrome 16 profile, and the compatible |
| | scalable format range extensions profiles of the |
| | Scalable Monochrome 16 profile |
| Scalable Main 4:4:4 | Scalable Main, Main, Main Still Picture, the |
| | compatible format range extensions profiles of the |
| | Main 4:4:4 profile, and the compatible scalable |
| | format range extensions profiles of the Scalable Main |
| | 4:4:4 profile |
| Multiview Main | Multiview Main, Main, Main Still Picture |
| Multiview Main 10 | Multiview Main 10, Main, Main Still Picture, Main |
| | 10, Multiview Main |
| Multiview Monochrome | Multiview Monochrome, Monochrome |
| Multiview Monochrome 10 | Multiview Monochrome 10, Multiview Monochrome, |
| | Monochrome 10, Monochrome |
| Multiview Monochrome 12 | Multiview Monochrome 12, Multiview Monochrome |
| | 10, Multiview Monochrome, Monochrome 12, |
| | Monochrome 10, Monochrome |
| Multiview Monochrome | Multiview Monochrome 16, Multiview |
| 16 | Monochrome 12, Multiview Monochrome 10, |
| | Multiview Monochrome, Monochrome 16, |
| | Monochrome 12, Monochrome 10, Monochrome |
| 3D Main | 3D Main, Multiview Main, Main, Main Still Picture |

. . . .

### G.3 Definitions

For the purpose of this annex, the following definitions apply in addition to the definitions in clause F.3.
auxiliary depth layer: A layer with a nuh_layer_id value equal to i, such that DepthLayerFlag[i] and DependencyId[i] are both equal to 0 and AuxId[i] is equal to AUX_DEPTH.
NOTE Readers should not be confused between the term “auxiliary depth layer” here with the term “depth layer” defined in Annex I as a layer with a nuh_layer_id value equal to i such that DepthLayerFlag[i] is equal to 1 and DependencyId[i] and AuxId[i] are both equal to 0.
texture layer: A layer with a nuh_layer_id value equal to i, such that DepthLayerFlag[i], DependencyId[i], and AuxId[i] are all equal to 0.
   . . . .

### G.11.1.1 Multiview Main and Multiview Main 10 Profiles

For a layer in an output operation point associated with an OLS in a bitstream, the layer being conforming to the Multiview Main or Multiview Main 10 profile, the following applies:
Let olsIdx be the OLS index of the OLS, the sub-bitstream subBitstream and the base layer sub-bitstream baseBitstream are derived as specified in F.11.3.
   When vps_base_layer_internal_flag is equal to 1, the base layer sub-bitstream baseBitstream shall obey the following constraints:
When the layer conforms to the Multiview Main profile, the base layer sub-bitstream baseBitstream shall be indicated to conform to the Main profile.
When the layer conforms to the Multiview Main 10 profile, the base layer sub-bitstream baseBitstream shall be indicated to conform to the Main 10 or the Main profile.
   The sub-bitstream subBitstream shall obey the following constraints:
All active VPSs shall have vps_num_rep_formats_minus1 in the range of 0 to 15, inclusive.
When the layer conforms to the Multiview Main profile, all active SPSs for layers in subBitstream shall have chroma_format_idc equal to 1 only.
When the layer conforms to the Multiview Main 10 profile, all active SPSs for a texture layer in subBitstream shall have chroma_format_idc equal to 1 only, and all active SPSs for an auxiliary depth layer in subBitstream shall have chroma_format_idc equal to 0 or 1.
When the layer conforms to the Multiview Main 10 profile, for a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, and AuxId[i] shall be equal to AuxId[j].
All active SPSs for layers in subBitstream shall have transform_skip_rotation_enabled_flag, transform_skip_context_enabled_flag, implicit_rdpcm_enabled_flag, explicit_rdpcm_enabled_flag, extended_precision_processing_flag, intra_smoothing_disabled_flag, high_precision_offsets_enabled_flag, persistent_rice_adaptation_enabled_flag, and cabac_bypass_alignment_enabled_flag, when present, equal to 0 only.
Ctb Log 2SizeY derived from all active SPSs for layers in subBitstream shall be in the range of 4 to 6, inclusive.
All active PPSs for layers in subBitstream shall have log 2_max_transform_skip_block_size_minus2 and chroma_qp_offset_list_enabled_flag, when present, equal to 0 only.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
When NumLayersInIdList[OlsIdxToLsIdx[olsIdx]] is equal to 2, output_layer_flag[olsIdx][j] derived according to any active VPS shall be equal to 1 for j in the range of 0 to 1, inclusive, for subBitstream.
All active VPSs shall have alt_output_layer_flag[olsIdx] equal to 0 only.
When ViewOrderIdx[i] derived according to any active VPS is equal to 1 for the layer with nuh_layer_id equal to i in subBitstream, inter_view_mv_vert_constraint_flag shall be equal to 1 in the sps_multilayer_extension( ) syntax structure in each active SPS for that layer.
When ViewOrderIdx[i] derived according to any active VPS is greater than to 0 for the layer with nuh_layer_id equal to i in subBitstream, num_ref_loc_offsets shall be equal to 0 in each active PPS for that layer.
When ViewOrderIdx[i] derived according to any active VPS is greater than 0 for the layer with nuh_layer_id equal to i in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When the layer conforms to the Multiview Main 10 profile and there are two different layers, a texture layer and an auxiliary depth layer, with nuh_layer_id equal to i andj in subBitstream, and ViewOrderIdx[i] is equal to ViewOrderIdx[j], the value of pic_width_in_luma_samples and pic_height_in_luma_samples in each active SPS for the auxiliary depth layer shall be less than or equal to the values of pic_width_in_luma_samples and pic_height_in_luma_samples, respectively, in each active SPS for the texture layer.
For a layer with nuh_layer_id iNuhLId equal to any value included in layerIdListTarget that was used to derive subBitstream, the value of NumRefLayers[iNuhLId], which specifies the total number of direct and indirect reference layers and is derived as specified in F.7.4.3.1, shall be less than or equal to 4.
All active SPSs for layers in subBitstream shall have sps_range_extension_flag and sps_scc_extension_flag equal to 0 only.
All active PPSs for layers in subBitstream shall have pps_range_extension_flag and pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, ViewOrderIdx[i] shall be greater than ViewOrderIdx[j] for any values of i and j among layerIdListTarget that was used to derive subBitstream such that AuxId[i] is equal to AuxId[j] and i is greater than j.
All active PPSs for layers in subBitstream shall have colour_mapping_enabled_flag equal to 0 only.
   When the layer conforms to the Multiview Main profile, the sub-bitstream subBitstream shall obey the following constraints:
All active SPSs for layers in subBitstream shall have bit_depth_luma_minus8 equal to 0 only.
All active SPSs for layers in subBitstream shall have bit_depth_chroma_minus8 equal to 0 only.
The tier and level constraints specified for the Multiview Main profile in G.11.2 shall be fulfilled.
   When the layer conforms to the Multiview Main 10 profile, the sub-bitstream subBitstream shall obey the following constraints:
All active SPSs for a texture layer in subBitstream shall have bit_depth_luma_minus8 in the range of 0 to 2, inclusive, and all active SPSs for an auxiliary depth layer in subBitstream shall have bit_depth_luma_minus8 in the range of 0 to 8, inclusive.
All active SPSs for a texture layer in subBitstream shall have bit_depth_chroma_minus8 in the range of 0 to 2, inclusive, and all active SPSs for an auxiliary depth layer in subBitstream shall have bit_depth_chroma_minus8 in the range of 0 to 8, inclusive.
For a layer layerA with nuh_layer_id equal to i in subBitstream and another layer layerB with nuh_layer_id equal to j, when layerB is a reference layer of layerA, the value of bit_depth_luma_minus8 for layerA and the value of bit_depth_luma_minus8 for layerB shall be identical, and the value of bit_depth_chroma_minus8 for layerA and the value of bit_depth_chroma_minus8 for layerB shall be identical.
The tier and level constraints specified for the Multiview Main 10 profile in G.11.2 shall be fulfilled.
   In the remainder of this subclause and G.11.2.1, all syntax elements in the profile_tier_level( ) syntax structure refer to those in the profile_tier_level( ) syntax structure associated with the layer.
   Conformance of a layer in an output operation point associated with an OLS in a bitstream to the Multiview Main profile is indicated as follows:
If OpTid of the output operation point is equal to vps_max_sub_layer_minus1, the conformance is indicated by having both of the following conditions satisfied:
   general_profile_idc being equal to 6 or general_profile_compatibility_flag[6] being equal to 1,
   general_max_12bit_constraint_flag being equal to 1, general_max_10bit_constraint_flag being equal to 1, general_max_8bit_constraint_flag being equal to 1, general_max_422chroma_constraint_flag being equal to 1, general_max_420chroma_constraint_flag being equal to 1, general_max_monochrome_constraint_flag being equal to 0, general_intra_constraint_flag being equal to 0, general_one_picture_only_constraint_flag being equal to 0, and general_lower_bit_rate_constraint_flag being equal to 1
Otherwise (OpTid of the output operation point is less than vps_max_sub_layer_minus1), the conformance is indicated by having both of the following conditions satisfied:
   sub_layer_profile_idc[OpTid] being equal to 6 or sub_layer_profile_compatibility_flag[OpTid][6] being equal to 1
   sub_layer_max_12bit_constraint_flag[OpTid] being equal to 1, sub_layer_max_10bit_constraint_flag[OpTid] being equal to 1, sub_layer_max_8bit_constraint_flag[OpTid] being equal to 1, sub_layer_max_422chroma_constraint_flag[OpTid] being equal to 1, sub_layer_max_420chroma_constraint_flag[OpTid] being equal to 1, sub_layer_max_monochrome_constraint_flag[OpTid] being equal to 0, sub_layer_intra_constraint_flag[OpTid] being equal to 0, sub_layer_one_picture_only_constraint_flag[OpTid] being equal to 0, and sub_layer_lower_bit_rate_constraint_flag[OpTid] being equal to 1
      Conformance of a layer in an output operation point associated with an OLS in a bitstream to the Multiview Main 10 profile is indicated as follows:
If OpTid of the output operation point is equal to vps_max_sub_layer_minus1, the conformance is indicated by having both of the following conditions satisfied:
   general_profile_idc being equal to 6 or general_profile_compatibility_flag[6] being equal to 1,
   general_max_12bit_constraint_flag being equal to 1, general_max_10bit_constraint_flag being equal to 1, general_max_8bit_constraint_flag being equal to 0, general_max_422chroma_constraint_flag being equal to 1, general_max_420chroma_constraint_flag being equal to 1, general_max_monochrome_constraint_flag being equal to 0, general_intra_constraint_flag being equal to 0, general_one_picture_only_constraint_flag being equal to 0, and general_lower_bit_rate_constraint_flag being equal to 1.
Otherwise (OpTid of the output operation point is less than vps_max_sub_layer_minus1), the conformance is indicated by having both of the following conditions satisfied:
   sub_layer_profile_idc[OpTid] being equal to 6 or sub_layer_profile_compatibility_flag[OpTid][6] being equal to 1
   sub_layer_max_12bit_constraint_flag[OpTid] being equal to 1, sub_layer_max_10bit_constraint_flag[OpTid] being equal to 1, sub_layer_max_8bit_constraint_flag[OpTid] being equal to 0, sub_layer_max_422chroma_constraint_flag[OpTid] being equal to 1, sub_layer_max_420chroma_constraint_flag[OpTid] being equal to 1, sub_layer_max_monochrome_constraint_flag[OpTid] being equal to 0, sub_layer_intra_constraint_flag[OpTid] being equal to 0, sub_layer_one_picture_only_constraint_flag[OpTid] being equal to 0, and sub_layer_lower_bit_rate_constraint_flag[OpTid] being equal to 1.

### G.11.1.2 Multiview Format Range Extensions Profiles

The following profiles, collectively referred to as the multiview format range extensions profiles, are specified in this subclause:
the Multiview Monochrome, Multiview Monochrome 10, Multiview Monochrome 12, and Multiview Monochrome 16 profiles.
   For a layer in an output operation point associated with an OLS in a bitstream, the layer being conforming to the Multiview Monochrome, Multiview Monochrome 10, Multiview Monochrome 12, or Multiview Monochrome 16 profile, the following applies:
Let olsIdx be the OLS index of the OLS, the sub-bitstream subBitstream is derived as specified in F.11.3.
   The sub-bitstream subBitstream shall obey the following constraints:
All active VPSs shall have vps_num_rep_formats_minus1 in the range of 0 to 15, inclusive.
All active SPSs for a layer conforming to the Multiview Monochrome, Multiview Monochrome 10, Multiview Monochrome 12 or Multiview Monochrome 16 profile in subBitstream shall have chroma_format_idc equal to 0 only.
All active SPSs for layers in subBitstream shall have separate_colour_plane_flag, cabac_bypass_alignment_enabled_flag, when present, equal to 0 only.
Ctb Log 2SizeY derived from all active SPSs for layers in subBitstream shall be in the range of 4 to 6, inclusive.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
The constraints specified in Table H.3, in which entries marked with “−” indicate that the table entry does not impose a profile-specific constraint on the corresponding syntax element, shall apply for all active SPSs and PPSs for layers in subBitstream.
NOTE For some syntax elements with table entries marked with “−”, a constraint may be imposed indirectly—e.g. by semantics constraints that are imposed elsewhere in this document when other specified constraints are fulfilled.
For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, the value of bit_depth_luma_minus8 for layerA and the value of bit_depth_luma_minus8 for layerB shall be identical, the value of bit_depth_chroma_minus8 for layerA and the value of bit_depth_chroma_minus8 for layerB shall be identical, and AuxId[i] shall be equal to AuxId[j].
For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When there are two different layers, a texture layer and an auxiliary depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the auxiliary depth layer shall be less than or equal to the values of pic_width_in_luma_samples and pic_height_in_luma_samples, respectively, in each active SPS for the texture layer.
All active SPSs for layers in subBitstream shall have sps_scc_extension_flag equal to 0 only.
All active PPSs for layers in subBitstream shall have pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, DependencyId[i] shall be greater than DependencyId[ji] for any values of i and j among layerIdListTarget that was used to derive subBitstream such that AuxId[i] is equal to AuxId[j] and i is greater than j.
The tier and level constraints specified for the Multiview Monochrome, Multiview Monochrome 10, and Multiview Monochrome 12 profiles in G.11.2, as applicable, shall be fulfilled.

TABLE G.3
Allowed values for syntax elements in the multiview format range extensions profiles

| | | | transform_skip_rotation_enabled_flag, |
|---|---|---|---|
| | | | transform_skip_context_enabled_flag, |
| | | | implicit_rdpcm_enabled_flag, |
| | | | explicit_rdpcm_enabled_flag, |
| Profile for which | | bit_depth_luma_minus8 and | intra_smoothing_disabled_flag, |
| constraint is specified | chroma_format_idc | bit_depth_chroma_minus8 | [symbol] |
| Multiview Monochrome | 0 | 0 | 0 |
| Multiview Monochrome 10 | 0 | 0 . . . 2 | 0 |
| Multiview Monochrome 12 | 0 | 0 . . . 4 | 0 |
| Multiview Monochrome 16 | 0 | 0 . . . 8 | 0 |

| Profile for which | | |
|---|---|---|
| constraint is specified | extended_precision_processing_flag | chroma_qp_offset_list_enabled_flag |
| Multiview Monochrome | 0 | 0 |
| Multiview Monochrome 10 | 0 | 0 |
| Multiview Monochrome 12 | 0 | 0 |
| Multiview Monochrome 16 | 0 | 0 |

[symbol]

indicates data missing or illegible when filed

In the remainder of this subclause and H.11.2.1, all syntax elements in the profile_tier_level( ) syntax structure refer to those in the profile_tier_level( ) syntax structure associated with the layer.
Conformance of a layer in an output operation point associated with an OLS in a bitstream for the multiview format range extensions profiles is indicated as follows:
If OpTid of the output operation point is equal to vps_max_sub_layer_minus1, the conformance is indicated by general_profile_idc being equal to 10 or general_profile_compatibility_flag[10] being equal to 1, with the additional indications specified in Table H.4 for the general constraint flags.
Otherwise (OpTid of the output operation point is less than vps_max_sub_layer_minus1), the conformance is indicated by sub_layer_profile_idc[OpTid] being equal to 10 or sub_layer_profile_compatibility_flag[OpTid][10] being equal to 1, with the additional indications specified in Table H.4 for the flags associated with the index OpTid.
   All other combinations of general_max_14bit_constraint_flag, general_max_12bit_constraint_flag, general_max_10bit_constraint_flag, general_max_8bit_constraint_flag, general_max_422chroma_constraint_flag, general_max_420chroma_constraint_flag, general_max_monochrome_constraint_flag, general_intra_constraint_flag, general_one_picture_only_constraint_flag, and general_lower_bit_rate_constraint_flag with general_profile_idc equal to 10 or general_profile_compatibility_flag[10] equal to 1 are reserved for future use by ITU-T|ISO/IEC. All other combinations of sub_layer_max_14bit_constraint_flag[OpTid], sub_layer_max_12bit_constraint_flag[OpTid], sub_layer_max_10bit_constraint_flag[OpTid], sub_layer_max_8bit_constraint_flag[OpTid], sub_layer_max_422chroma_constraint_flag[OpTid], sub_layer_max_420chroma_constraint_flag[OpTid], sub_layer_max_monochrome_constraint_flag[OpTid], sub_layer_intra_constraint_flag[OpTid], sub_layer_one_picture_only_constraint_flag[OpTid], and sub_layer_lower_bit_rate_constraint_flag[OpTid] with sub_layer_profile_idc[OpTid] equal to 10 or sub_layer_profile_compatibility_flag[OpTid][10] equal to 1 are reserved for future use by ITU-T|ISO/IEC. Such combinations shall not be present in bitstreams conforming to this document. However, decoders conforming to the multiview format range extensions profiles shall allow other combinations as specified below in this clause to occur in the bitstream.

TABLE G.4
Bitstream indications for conformance to multiview range extensions profiles

| | general_{—} | general_{—} | general_{—} | general_{—} | |
|---|---|---|---|---|---|
| | max_14bit_{—} | max_12bit_{—} | max_10bit_{—} | max_8bit_{—} | |
| Profile for | constraint_{—} | constraint_{—} | constraint_{—} | constraint_{—} | |
| which the | flag or | flag or | flag or | flag or | general_{—} |
| bitstream | sub_layer_{—} | sub_layer_{—} | sub_layer_{—} | sub_layer_{—} | max_422chroma_{—} |
| indicates | max_14bit_{—} | max_12bit_{—} | max_10bit_{—} | max_8bit_{—} | constraint_{—} |
| conformance | constraint_{—} | constraint_{—} | constraint_{—} | constraint_{—} | flag or |
| Multiview | 1 | 1 | 1 | 1 | 1 |
| Monochrome | | | | | |
| Multiview | 1 | 1 | 1 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 0 | 0 | 0 | 0 | 1 |
| Monochrome | | | | | |
| 16 | | | | | |

| | | | | | general_{—} |
|---|---|---|---|---|---|
| | | | general_{—} | | lower_{—} |
| | | | intra_{—} | | bit_rate_{—} |
| | | | constraint_{—} | general_{—} | constraint_{—} |
| Profile for | general_{—} | general_{—} | flag or | one_{—} | flag or |
| which the | max_{—} | max_{—} | sub_layer_{—} | picture_{—} | sub_layer_{—} |
| bitstream | 420chroma_{—} | monochrome_{—} | intra_{—} | only_{—} | lower_{—} |
| indicates | constraint_{—} | constraint_{—} | constraint_{—} | constraint_{—} | bit_rate_{—} |
| conformance | flag or | flag or | flag[ OpTid ] | flag or | constraint_{—} |
| Multiview | 1 | 1 | 0 | 0 | 1 |
| Monochrome | | | | | |
| Multiview | 1 | 1 | 0 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 1 | 1 | 0 | 0 | 1 |
| Monochrome | | | | | |
| 16 | | | | | |

. . . .

### G.11.2.1 General Tier and Level Limits

For purposes of comparison of tier capabilities, the tier with general_tier_flag or sub_layer_tier_flag[i] equal to 0 is considered to be a lower tier than the tier with general_tier_flag or sub_layer_tier_flag[i] equal to 1.
For purposes of comparison of level capabilities, a particular level of a specific tier is considered to be a lower level than some other level of the same tier when the value of the general_level_idc or sub_layer_level_idc[i] of the particular level is less than that of the other level.
The following is specified for expressing the constraints in this subclause and H.11.2.2:
For the Multiview Main profile, the value of each of the variables CpbVclFactor, CpbNalFactor, FormatCapabilityFactor, and MinCrScaleFactor is the same as that specified in Table A.10 for the Main profile. For the Multiview Main 10 profile, the value of each of these variables is the same as that specified in Table A.10 for the Main 10 profile.
For the Multiview Monochrome profile, the value of each of the variables CpbVclFactor, CpbNalFactor, FormatCapabilityFactor, and MinCrScaleFactor is the same as that specified in Table A.10 for the Monochrome profile.
For the Multiview Monochrome 10 profile, the value of each of the variables CpbVclFactor, CpbNalFactor, FormatCapabilityFactor, and MinCrScaleFactor is the same as that specified in Table A.10 for the Monochrome 10 profile.
For the Multiview Monochrome 12 profile, the value of each of the variables CpbVclFactor, CpbNalFactor, FormatCapabilityFactor, and MinCrScaleFactor is the same as that specified in Table A.10 for the Monochrome 12 profile.
For the Multiview Monochrome 16 profile, the value of each of the variables CpbVclFactor, CpbNalFactor, FormatCapabilityFactor, and MinCrScaleFactor is the same as that specified in Table A.10 for the Monochrome 16 profile.
   . . . .

### 5.5 Embodiment 5

In this embodiment, changes are not indicated.

### F.7.4.3.1.1 Video Parameter Set Extension Semantics

. . .
scalability_mask_flag[i] equal to 1 indicates that dimension_id syntax elements corresponding to the i-th scalability dimension in Table F.1 are present. scalability_mask_flag[i] equal to 0 indicates that dimension_id syntax elements corresponding to the i-th scalability dimension are not present.

TABLE F.1
Mapping of ScalabiltyId to scalability dimensions

| Scalability | Scalability | ScalabilityId |
|---|---|---|
| mask index | dimension | mapping |
| 0 | Texture or depth | DepthLayerFlag |
| 1 | Multiview | ViewOrderIdx |
| 2 | Spatial/quality | DependencyId |
| | scalability | |
| 3 | Auxiliary | AuxId |
| 4-15 | Reserved | |

. . .

TABLE F.2
Mapping of AuxId to the type of auxiliary pictures

| | | | SEI message describing interpretation |
|---|---|---|---|
| AuxId | Name of AuxId | Type of auxiliary pictures | of auxiliary pictures |
| 1 | AUX_ALPHA | Alpha plane | Alpha channel information |
| 2 | AUX_DEPTH | Depth picture | Depth representation information |
| 3 . . . 127 | | Reserved | |
| 128 . . . 159 | | Unspecified | |
| 160 . . . 255 | | Reserved | |

. . . .

### F.11.2 Decoder Capabilities

. . .

TABLE F.3
Specification of CompatibleProfileList

| Profile to which | Profiles that the decoder shall support |
|---|---|
| the decoder conforms | CompatibleProfileList |
| Scalable Main | Scalable Main, Main, Main Still Picture |
| Scalable Main 10 | Scalable Main 10, Main, Main Still Picture, Main 10, |
| | Scalable Main |
| Scalable Monochrome | The compatible format range extensions profiles of |
| | the Monochrome profile, and the compatible scalable |
| | format range extensions profiles of the Scalable |
| | Monochrome profile |
| Scalable Monochrome 12 | The compatible format range extensions profiles of |
| | the Monochrome 12 profile, and the compatible |
| | scalable format range extensions profiles of the |
| | Scalable Monochrome 12 profile |
| Scalable Monochrome 16 | The compatible format range extensions profiles of |
| | the Monochrome 16 profile, and the compatible |
| | scalable format range extensions profiles of the |
| | Scalable Monochrome 16 profile |
| Scalable Main 4:4:4 | Scalable Main, Main, Main Still Picture, the |
| | compatible format range extensions profiles of the |
| | Main 4:4:4 profile, and the compatible scalable |
| | format range extensions profiles of the Scalable Main |
| | 4:4:4 profile |
| Multiview Main | Multiview Main, Main, Main Still Picture |
| Multiview Main 10 | Multiview Main 10, Main, Main Still Picture, Main |
| | 10, Multiview Main |
| Multiview Monochrome | Multiview Monochrome, Monochrome |
| Multiview Monochrome 10 | Multiview Monochrome 10, Multiview Monochrome, |
| | Monochrome 10, Monochrome |
| Multiview Monochrome 12 | Multiview Monochrome 12, Multiview Monochrome |
| | 10, Multiview Monochrome, Monochrome 12, |
| | Monochrome 10, Monochrome |
| Multiview Monochrome | Multiview Monochrome 16, Multiview |
| 16 | Monochrome 12, Multiview Monochrome 10, |
| | Multiview Monochrome, Monochrome 16, |
| | Monochrome 12, Monochrome 10, Monochrome |
| 3D Main | 3D Main, Multiview Main, Main, Main Still Picture |

. . . .

### G.3 Definitions

For the purpose of this annex, the following definitions apply in addition to the definitions in clause F.3.
auxiliary depth layer: A layer with a nuh_layer_id value equal to i, such that DepthLayerFlag[i] and DependencyId[i] are both equal to 0 and AuxId[i] is equal to AUX_DEPTH.
NOTE Readers should not be confused between the term “auxiliary depth layer” here with the term “depth layer” defined in Annex I as a layer with a nuh_layer_id value equal to i such that DepthLayerFlag[i] is equal to 1 and DependencyId[i] and AuxId[i] are both equal to 0.
texture layer: A layer with a nuh_layer_id value equal to i, such that DepthLayerFlag[i], DependencyId[i], and AuxId[i] are all equal to 0.
   . . . .

### G.11.1.1 Multiview Main, Extended Multiview Main, Multiview Main 10, and Extended Multiview Main 10 Profiles

For a layer in an output operation point associated with an OLS in a bitstream, the layer being conforming to the Multiview Main, Extended Multiview Main, Multiview Main 10, or Extended Multiview Main 10 profile, the following applies:
Let olsIdx be the OLS index of the OLS, the sub-bitstream subBitstream and the base layer sub-bitstream baseBitstream are derived as specified in F.11.3.
   When vps_base_layer_internal_flag is equal to 1, the base layer sub-bitstream baseBitstream shall obey the following constraints:
When the layer conforms to the Multiview Main or Extended Multiview Main profile, the base layer sub-bitstream baseBitstream shall be indicated to conform to the Main profile.
When the layer conforms to the Multiview Main 10 or Extended Multiview Main 10 profile, the base layer sub-bitstream baseBitstream shall be indicated to conform to the Main 10 or the Main profile.
   The sub-bitstream subBitstream shall obey the following constraints:
All active VPSs shall have vps_num_rep_formats_minus1 in the range of 0 to 15, inclusive.
When the layer conforms to the Multiview Main or Multiview Main 10 profile, all active SPSs for layers in subBitstream shall have chroma_format_idc equal to 1 only.
When the layer conforms to the Extended Multiview Main or Extended Multiview Main 10 profile, all active SPSs for a texture layer in subBitstream shall have chroma_format_idc equal to 1 only, and all active SPSs for an auxiliary depth layer in subBitstream shall have chroma_format_idc equal to 0 or 1.
When the layer conforms to the Extended Multiview Main, Multiview Main 10, or Extended Multiview Main 10 profile, for a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, and AuxId[i] shall be equal to AuxId[j].
All active SPSs for layers in subBitstream shall have transform_skip_rotation_enabled_flag, transform_skip_context_enabled_flag, implicit_rdpcm_enabled_flag, explicit_rdpcm_enabled_flag, extended_precision_processing_flag, intra_smoothing_disabled_flag, high_precision_offsets_enabled_flag, persistent_rice_adaptation_enabled_flag, and cabac_bypass_alignment_enabled_flag, when present, equal to 0 only.
Ctb Log 2SizeY derived from all active SPSs for layers in subBitstream shall be in the range of 4 to 6, inclusive.
All active PPSs for layers in subBitstream shall have log 2_max_transform_skip_block_size_minus2 and chroma_qp_offset_list_enabled_flag, when present, equal to 0 only.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
When NumLayersInIdList[OlsIdxToLsIdx[olsIdx]] is equal to 2, output_layer_flag[olsIdx][j] derived according to any active VPS shall be equal to 1 for j in the range of 0 to 1, inclusive, for subBitstream.
All active VPSs shall have alt_output_layer_flag[olsIdx] equal to 0 only.
When ViewOrderIdx[i] derived according to any active VPS is equal to 1 for the layer with nuh_layer_id equal to i in subBitstream, inter_view_mv_vert_constraint_flag shall be equal to 1 in the sps_multilayer_extension( ) syntax structure in each active SPS for that layer.
When ViewOrderIdx[i] derived according to any active VPS is greater than to 0 for the layer with nuh_layer_id equal to i in subBitstream, num_ref_loc_offsets shall be equal to 0 in each active PPS for that layer.
When ViewOrderIdx[i] derived according to any active VPS is greater than 0 for the layer with nuh_layer_id equal to i in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When the layer conforms to the Extended Multiview Main, Multiview Main 10 profile, or Extended Multiview Main 10 profile and there are two different layers, a texture layer and an auxiliary depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the auxiliary depth layer shall be less than or equal to the values of pic_width_in_luma_samples and pic_height_in_luma_samples, respectively, in each active SPS for the texture layer.
For a layer with nuh_layer_id iNuhLId equal to any value included in layerIdListTarget that was used to derive subBitstream, the value of NumRefLayers[iNuhLId], which specifies the total number of direct and indirect reference layers and is derived as specified in F.7.4.3.1, shall be less than or equal to 4.
All active SPSs for layers in subBitstream shall have sps_range_extension_flag and sps_scc_extension_flag equal to 0 only.
All active PPSs for layers in subBitstream shall have pps_range_extension_flag and pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, ViewOrderIdx[i] shall be greater than ViewOrderIdx[j] for any values of i and j among layerIdListTarget that was used to derive subBitstream such that AuxId[i] is equal to AuxId[j] and i is greater than j.
All active PPSs for layers in subBitstream shall have colour_mapping_enabled_flag equal to 0 only.
   When the layer conforms to the Multiview Main or Extended Multiview Main profile, the sub-bitstream subBitstream shall obey the following constraints:
All active SPSs for layers in subBitstream shall have bit_depth_luma_minus8 equal to 0 only.
All active SPSs for layers in subBitstream shall have bit_depth_chroma_minus8 equal to 0 only.
When the layer conforms to the Multiview Main profile, the tier and level constraints specified for the Multiview Main profile in G.11.2 shall be fulfilled.
When the layer conforms to the Extended Multiview Main profile, the tier and level constraints specified for the Extended Multiview Main profile in G.11.2 shall be fulfilled.
   When the layer conforms to the Multiview Main 10 or Extended Multiview Main 10 profile, the sub-bitstream subBitstream shall obey the following constraints:
All active SPSs for a texture layer in subBitstream shall have bit_depth_luma_minus8 in the range of 0 to 2, inclusive, and all active SPSs for an auxiliary depth layer in subBitstream shall have bit_depth_luma_minus8 in the range of 0 to 8, inclusive.
All active SPSs for a texture layer in subBitstream shall have bit_depth_chroma_minus8 in the range of 0 to 2, inclusive, and all active SPSs for an auxiliary depth layer in subBitstream shall have bit_depth_chroma_minus8 in the range of 0 to 8, inclusive.
For a layer layerA with nuh_layer_id equal to i in subBitstream and another layer layerB with nuh_layer_id equal to j, when layerB is a reference layer of layerA, the value of bit_depth_luma_minus8 for layerA and the value of bit_depth_luma_minus8 for layerB shall be identical, and the value of bit_depth_chroma_minus8 for layerA and the value of bit_depth_chroma_minus8 for layerB shall be identical.
When the layer conforms to the Multiview Main profile 10, the tier and level constraints specified for the Multiview Main 10 profile in G.11.2 shall be fulfilled.
When the layer conforms to the Extended Multiview Main profile 10, the tier and level constraints specified for the Extended Multiview Main 10 profile in G.11.2 shall be fulfilled.
   In the remainder of this subclause and G.11.2.1, all syntax elements in the profile_tier_level( ) syntax structure refer to those in the profile_tier_level( ) syntax structure associated with the layer.
   Conformance of a layer in an output operation point associated with an OLS in a bitstream to the Multiview Main profile is indicated as follows:
If OpTid of the output operation point is equal to vps_max_sub_layer_minus1, the conformance is indicated by having both of the following conditions satisfied:
   general_profile_idc being equal to 6 or general_profile_compatibility_flag[6] being equal to 1,
   general_max_12bit_constraint_flag being equal to 1, general_max_10bit_constraint_flag being equal to 1, general_max_8bit_constraint_flag being equal to 1, general_max_422chroma_constraint_flag being equal to 1, general_max_420chroma_constraint_flag being equal to 1, general_max_monochrome_constraint_flag being equal to 0, general_intra_constraint_flag being equal to 0, general_one_picture_only_constraint_flag being equal to 0, and general_lower_bit_rate_constraint_flag being equal to 1
Otherwise (OpTid of the output operation point is less than vps_max_sub_layer_minus1), the conformance is indicated by having both of the following conditions satisfied:
   sub_layer_profile_idc[OpTid] being equal to 6 or sub_layer_profile_compatibility_flag[OpTid][6] being equal to 1
   sub_layer_max_12bit_constraint_flag[OpTid] being equal to 1, sub_layer_max_10bit_constraint_flag[OpTid] being equal to 1, sub_layer_max_8bit_constraint_flag[OpTid] being equal to 1, sub_layer_max_422chroma_constraint_flag[OpTid] being equal to 1, sub_layer_max_420chroma_constraint_flag[OpTid] being equal to 1, sub_layer_max_monochrome_constraint_flag[OpTid] being equal to 0, sub_layer_intra_constraint_flag[OpTid] being equal to 0, sub_layer_one_picture_only_constraint_flag[OpTid] being equal to 0, and sub_layer_lower_bit_rate_constraint_flag[OpTid] being equal to 1
      Conformance of a bitstream to the Extended Multiview Main profile is indicated by general_profile_idc being equal to 12 or general_profile_compatibility_flag[12] being equal to 1. Conformance of a sub-layer representation with TemporalId equal to i to the Extended Multiview Main profile is indicated by sub_layer_profile_idc[i] being equal to 12 or sub_layer_profile_compatibility_flag[i][12] being equal to 1.
      Conformance of a layer in an output operation point associated with an OLS in a bitstream to the Multiview Main 10 profile is indicated as follows:
If OpTid of the output operation point is equal to vps_max_sub_layer_minus1, the conformance is indicated by having both of the following conditions satisfied:
   general_profile_idc being equal to 6 or general_profile_compatibility_flag[6] being equal to 1,
   general_max_12bit_constraint_flag being equal to 1, general_max_10bit_constraint_flag being equal to 1, general_max_8bit_constraint_flag being equal to 0, general_max_422chroma_constraint_flag being equal to 1, general_max_420chroma_constraint_flag being equal to 1, general_max_monochrome_constraint_flag being equal to 0, general_intra_constraint_flag being equal to 0, general_one_picture_only_constraint_flag being equal to 0, and general_lower_bit_rate_constraint_flag being equal to 1.
Otherwise (OpTid of the output operation point is less than vps_max_sub_layer_minus1), the conformance is indicated by having both of the following conditions satisfied:
   sub_layer_profile_idc[OpTid] being equal to 6 or sub_layer_profile_compatibility_flag[OpTid][6] being equal to 1
   sub_layer_max_12bit_constraint_flag[OpTid] being equal to 1, sub_layer_max_10bit_constraint_flag[OpTid] being equal to 1, sub_layer_max_8bit_constraint_flag[OpTid] being equal to 0, sub_layer_max_422chroma_constraint_flag[OpTid] being equal to 1, sub_layer_max_420chroma_constraint_flag[OpTid] being equal to 1, sub_layer_max_monochrome_constraint_flag[OpTid] being equal to 0, sub_layer_intra_constraint_flag[OpTid] being equal to 0, sub_layer_one_picture_only_constraint_flag[OpTid] being equal to 0, and sub_layer_lower_bit_rate_constraint_flag[OpTid] being equal to 1.
      Conformance of a bitstream to the Extended Multiview Main 10 profile is indicated by general_profile_idc being equal to 13 or general_profile_compatibility_flag[13] being equal to 1. Conformance of a sub-layer representation with TemporalId equal to i to the Extended Multiview Main 10 profile is indicated by sub_layer_profile_idc[i] being equal to 13 or sub_layer_profile_compatibility_flag[i][13] being equal to 1.

### G.11.1.2 Multiview Format Range Extensions Profiles

The following profiles, collectively referred to as the multiview format range extensions profiles, are specified in this subclause:
the Multiview Monochrome, Multiview Monochrome 10, Multiview Monochrome 12, and Multiview Monochrome 16 profiles.
   For a layer in an output operation point associated with an OLS in a bitstream, the layer being conforming to the Multiview Monochrome, Multiview Monochrome 10, Multiview Monochrome 12, or Multiview Monochrome 16 profile, the following applies:
Let olsIdx be the OLS index of the OLS, the sub-bitstream subBitstream is derived as specified in F.11.3.
   The sub-bitstream subBitstream shall obey the following constraints:
All active VPSs shall have vps_num_rep_formats_minus1 in the range of 0 to 15, inclusive.
All active SPSs for a layer conforming to the Multiview Monochrome, Multiview Monochrome 10, Multiview Monochrome 12 or Multiview Monochrome 16 profile in subBitstream shall have chroma_format_idc equal to 0 only.
All active SPSs for layers in subBitstream shall have separate_colour_plane_flag, cabac_bypass_alignment_enabled_flag, when present, equal to 0 only.
Ctb Log 2SizeY derived from all active SPSs for layers in subBitstream shall be in the range of 4 to 6, inclusive.
ScalabilityId[j][smIdx] derived according to any active VPS shall be equal to 0 for any smIdx value not equal to 1 or 3 and for any value of j such that layer_id_in_nuh[j] is among layerIdListTarget that was used to derive subBitstream.
The constraints specified in Table H.3, in which entries marked with “−” indicate that the table entry does not impose a profile-specific constraint on the corresponding syntax element, shall apply for all active SPSs and PPSs for layers in subBitstream.

NOTE For some syntax elements with table entries marked with “−”, a constraint may be imposed indirectly—e.g. by semantics constraints that are imposed elsewhere in this document when other specified constraints are fulfilled.
For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, the value of bit_depth_luma_minus8 for layerA and the value of bit_depth_luma_minus8 for layerB shall be identical, the value of bit_depth_chroma_minus8 for layerA and the value of bit_depth_chroma_minus8 for layerB shall be identical, and AuxId[i] shall be equal to AuxIId[j].
For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
When there are two different layers, a texture layer and an auxiliary depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the auxiliary depth layer shall be less than or equal to the values of pic_width_in_luma_samples and pic_height_in_luma_samples, respectively, in each active SPS for the texture layer.
All active SPSs for layers in subBitstream shall have sps_scc_extension_flag equal to 0 only.
All active PPSs for layers in subBitstream shall have pps_scc_extension_flag equal to 0 only.
When an active PPS for any layer in subBitstream has tiles_enabled_flag equal to 1, it shall have entropy_coding_sync_enabled_flag equal to 0.
When an active PPS for any layer in subBitstream has tiles_enabled_flag equal to 1, ColumnWidthInLumaSamples[i] shall be greater than or equal to 256 for all values of i in the range of 0 to num_tile_columns_minus1, inclusive, and RowHeightInLumaSamples[j] shall be greater than or equal to 64 for all values of j in the range of 0 to num_tile_rows_minus1, inclusive.
The number of times read_bits(1) is called in 9.3.4.3.3 and 9.3.4.3.4 when parsing coding_tree_unit( ) data for any CTU shall be less than or equal to 5*RawCtuBits/3.
For any active VPS, DependencyId[i] shall be greater than DependencyId[j] for any values of i and j among layerIdListTarget that was used to derive subBitstream such that AuxId[i] is equal to AuxId[j] and i is greater than j.
The tier and level constraints specified for the Multiview Monochrome, Multiview Monochrome 10, and Multiview Monochrome 12 profiles in G.11.2, as applicable, shall be fulfilled.

TABLE G.3
Allowed values for syntax elements in the multiview format range extensions profiles

| | | | transform_skip_rotation_enabled_flag, |
|---|---|---|---|
| | | | transform_skip_context_enabled_flag, |
| | | | implicit_rdpcm_enabled_flag, |
| | | | explicit_rdpcm_enabled_flag, |
| Profile for which | | bit_depth_luma_minus8 and | intra_smoothing_disabled_flag, |
| constraint is specified | chroma_format_idc | bit_depth_chroma_minus8 | [symbol] |
| Multiview Monochrome | 0 | 0 | 0 |
| Multiview Monochrome 10 | 0 | 0 . . . 2 | 0 |
| Multiview Monochrome 12 | 0 | 0 . . . 4 | 0 |
| Multiview Monochrome 16 | 0 | 0 . . . 8 | 0 |

| Profile for which | | |
|---|---|---|
| constraint is specified | extended_precision_processing_flag | chroma_qp_offset_list_enabled_flag |
| Multiview Monochrome | 0 | 0 |
| Multiview Monochrome 10 | 0 | 0 |
| Multiview Monochrome 12 | 0 | 0 |
| Multiview Monochrome 16 | 0 | 0 |

[symbol]

indicates data missing or illegible when filed

In the remainder of this subclause and H.11.2.1, all syntax elements in the profile_tier_level( ) syntax structure refer to those in the profile_tier_level( ) syntax structure associated with the layer.
Conformance of a layer in an output operation point associated with an OLS in a bitstream for the multiview format range extensions profiles is indicated as follows:
If OpTid of the output operation point is equal to vps_max_sub_layer_minus1, the conformance is indicated by general_profile_idc being equal to 10 or general_profile_compatibility_flag[10] being equal to 1, with the additional indications specified in Table H.4 for the general constraint flags.
Otherwise (OpTid of the output operation point is less than vps_max_sub_layer_minus1), the conformance is indicated by sub_layer_profile_idc[OpTid] being equal to 10 or sub_layer_profile_compatibility_flag[OpTid][10] being equal to 1, with the additional indications specified in Table H.4 for the flags associated with the index OpTid.
   All other combinations of general_max_14bit_constraint_flag, general_max_12bit_constraint_flag, general_max_10bit_constraint_flag, general_max_8bit_constraint_flag, general_max_422chroma_constraint_flag, general_max_420chroma_constraint_flag, general_max_monochrome_constraint_flag, general_intra_constraint_flag, general_one_picture_only_constraint_flag, and general_lower_bit_rate_constraint_flag with general_profile_idc equal to 10 or general_profile_compatibility_flag[10] equal to 1 are reserved for future use by ITU-T|ISO/IEC. All other combinations of sub_layer_max_14bit_constraint_flag[OpTid], sub_layer_max_12bit_constraint_flag[OpTid], sub_layer_max_10bit_constraint_flag[OpTid], sub_layer_max_8bit_constraint_flag[OpTid], sub_layer_max_422chroma_constraint_flag[OpTid], sub_layer_max_420chroma_constraint_flag[OpTid], sub_layer_max_monochrome_constraint_flag[OpTid], sub_layer_intra_constraint_flag[OpTid], sub_layer_one_picture_only_constraint_flag[OpTid], and sub_layer_lower_bit_rate_constraint_flag[OpTid] with sub_layer_profile_idc[OpTid] equal to 10 or sub_layer_profile_compatibility_flag[OpTid][10] equal to 1 are reserved for future use by ITU-T|ISO/IEC. Such combinations shall not be present in bitstreams conforming to this document. However, decoders conforming to the multiview format range extensions profiles shall allow other combinations as specified below in this clause to occur in the bitstream.

TABLE G.4
Bitstream indications for conformance to multiview range extensions profiles

| | general_{—} | general_{—} | general_{—} | general_{—} | |
|---|---|---|---|---|---|
| | max_14bit_{—} | max_12bit_{—} | max_10bit_{—} | max_8bit_{—} | |
| Profile for | constraint_{—} | constraint_{—} | constraint_{—} | constraint_{—} | |
| which the | flag or | flag or | flag or | flag or | general_{—} |
| bitstream | sub_layer_{—} | sub_layer_{—} | sub_layer_{—} | sub_layer_{—} | max_422chroma_{—} |
| indicates | max_14bit_{—} | max_12bit_{—} | max_10bit_{—} | max_8bit_{—} | constraint_{—} |
| conformance | constraint_{—} | constraint_{—} | constraint_{—} | constraint_{—} | flag or |
| Multiview | 1 | 1 | 1 | 1 | 1 |
| Monochrome | | | | | |
| Multiview | 1 | 1 | 1 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 0 | 0 | 0 | 0 | 1 |
| Monochrome | | | | | |
| 16 | | | | | |

| | | | | | general_{—} |
|---|---|---|---|---|---|
| | | | general_{—} | | lower_{—} |
| | | | intra_{—} | | bit_rate_{—} |
| | | | constraint_{—} | general_{—} | constraint_{—} |
| Profile for | general_{—} | general_{—} | flag or | one_{—} | flag or |
| which the | max_{—} | max_{—} | sub_layer_{—} | picture_{—} | sub_layer_{—} |
| bitstream | 420chroma_{—} | monochrome_{—} | intra_{—} | only_{—} | lower_{—} |
| indicates | constraint_{—} | constraint_{—} | constraint_{—} | constraint_{—} | bit_rate_{—} |
| conformance | flag or | flag or | flag[ OpTid ] | flag or | constraint_{—} |
| Multiview | 1 | 1 | 0 | 0 | 1 |
| Monochrome | | | | | |
| Multiview | 1 | 1 | 0 | 0 | 1 |
| Monochrome | | | | | |
| 10 | | | | | |
| Multiview | 1 | 1 | 0 | 0 | 1 |
| Monochrome | | | | | |
| 12 | | | | | |
| Multiview | 1 | 1 | 0 | 0 | 1 |
| Monochrome | | | | | |
| 16 | | | | | |

. . . .

### G.11.2.1 General Tier and Level Limits

For purposes of comparison of tier capabilities, the tier with general_tier_flag or sub_layer_tier_flag[i] equal to 0 is considered to be a lower tier than the tier with general_tier_flag or sub_layer_tier_flag[i] equal to 1. For purposes of comparison of level capabilities, a particular level of a specific tier is considered to be a lower level than some other level of the same tier when the value of the general_level_idc or sub_layer_level_idc[i] of the particular level is less than that of the other level.
The following is specified for expressing the constraints in this subclause and H.11.2.2:
For the Multiview Main and Extended Multiview Main profiles, the value of each of the variables CpbVclFactor, CpbNalFactor, FormatCapabilityFactor, and MinCrScaleFactor is the same as that specified in Table A.10 for the Main profile. For the Multiview Main 10 and Extended Multiview Main 10 profiles, the value of each of these variables is the same as that specified in Table A.10 for the Main 10 profile.
For the Multiview Monochrome profile, the value of each of the variables CpbVclFactor, CpbNalFactor, FormatCapabilityFactor, and MinCrScaleFactor is the same as that specified in Table A.10 for the Monochrome profile.
For the Multiview Monochrome 10 profile, the value of each of the variables CpbVclFactor, CpbNalFactor, FormatCapabilityFactor, and MinCrScaleFactor is the same as that specified in Table A.10 for the Monochrome 10 profile.
For the Multiview Monochrome 12 profile, the value of each of the variables CpbVclFactor, CpbNalFactor, FormatCapabilityFactor, and MinCrScaleFactor is the same as that specified in Table A.10 for the Monochrome 12 profile.
For the Multiview Monochrome 16 profile, the value of each of the variables CpbVclFactor, CpbNalFactor, FormatCapabilityFactor, and MinCrScaleFactor is the same as that specified in Table A.10 for the Monochrome 16 profile.
   . . . .

### 6. REFERENCES

[1] ITU-T and ISO/IEC, “High efficiency video coding”, Rec. ITU-T H.265|ISO/IEC 23008-2 (in force edition).
[2] J. Chen, E. Alshina, G. J. Sullivan, J.-R. Ohm, J. Boyce, “Algorithm description of Joint Exploration Test Model 7 (JEM7),” JVET-G1001, August 2017.
[3] Rec. ITU-T H.266|ISO/IEC 23090-3, “Versatile Video Coding”, 2022.
[4] Rec. ITU-T Rec. H.274|ISO/IEC 23002-7, “Versatile Supplemental Enhancement Information Messages for Coded Video Bitstreams”.
[5] B. Bross, T. Ikai, G. Sullivan, A. Tourapis, Y.-K. Wang (ed.), JVET-AE1006, “New profiles, colour descriptors, and SEI messages for HEVC (draft 1)”, publicly available herein: https://www.jvet-experts.org/doc_end_user/current_document.php?id=13266.

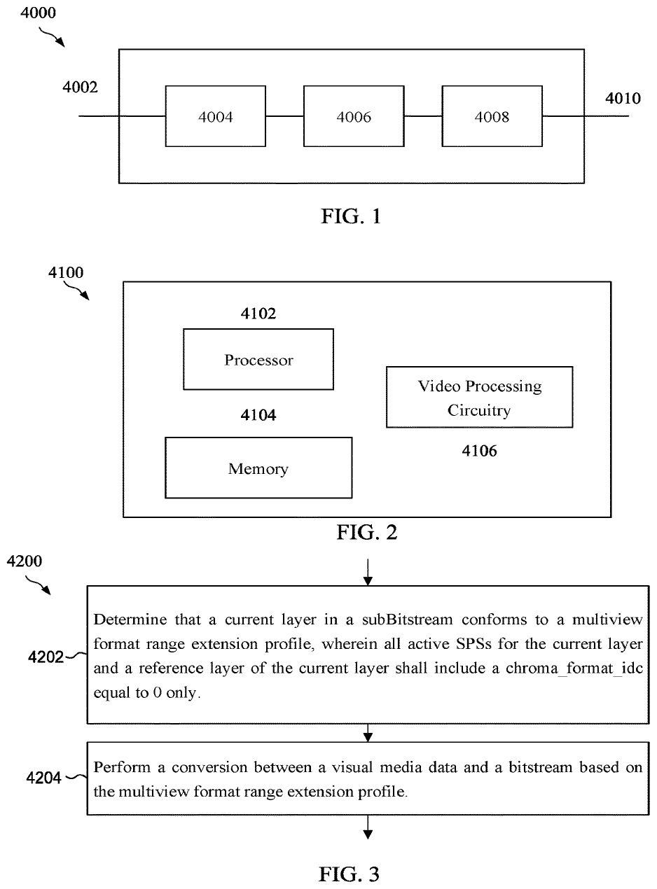

FIG. 1 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 2 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 3 is a flowchart for an example method 4200 of video processing. The method 4200 determines that a current layer in a sub-bitstream (subBitstream) conforms to a multiview format range extension profile, wherein all active sequence parameter sets (SPSs) for the current layer and a reference layer of the current layer shall include a chroma format identification code (chroma_format_idc) equal to 0 only at step 4202. A conversion between a visual media data and a bitstream is performed based on the multiview format range extension profile at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

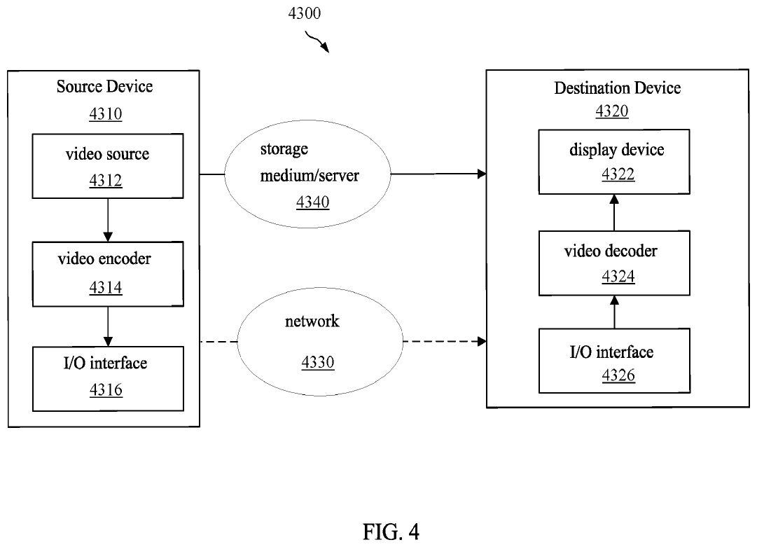

FIG. 4 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

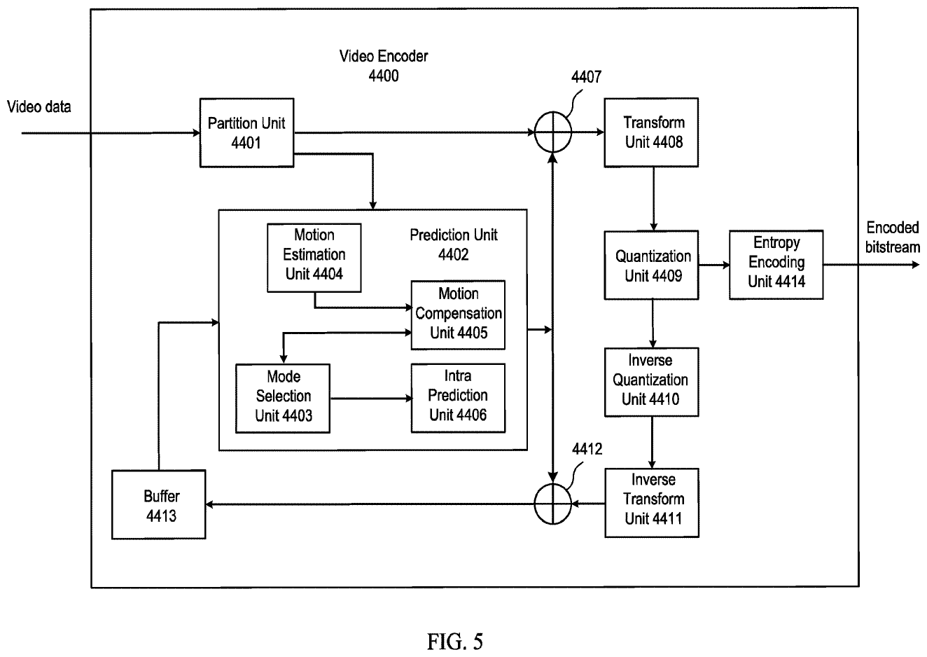

FIG. 5 is a block diagram illustrating an example of video encoder 4400, which may be video encoder 4314 in the system 4300 illustrated in FIG. 4. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

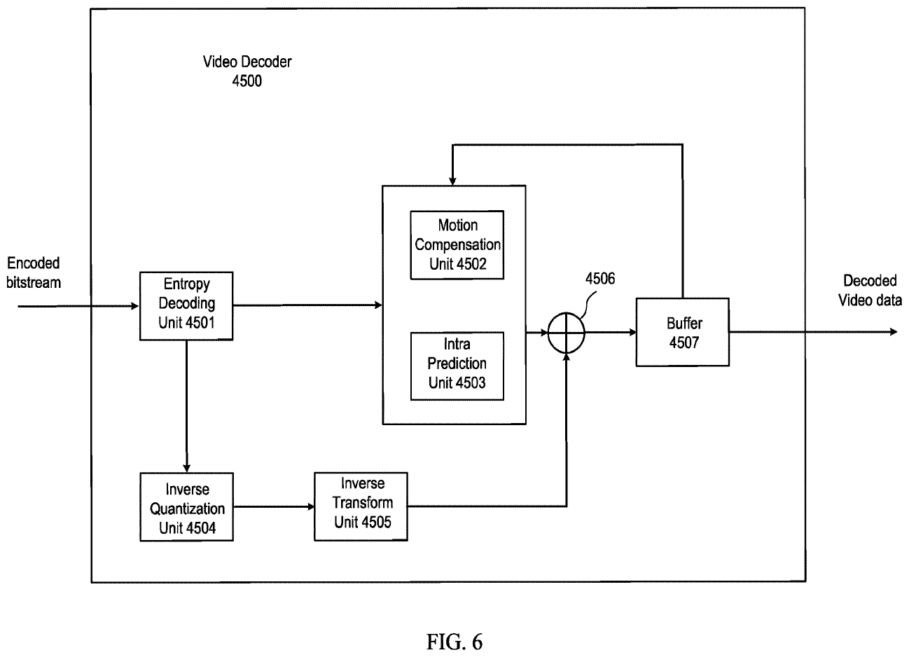

FIG. 6 is a block diagram illustrating an example of video decoder 4500 which may be video decoder 4324 in the system 4300 illustrated in FIG. 4. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

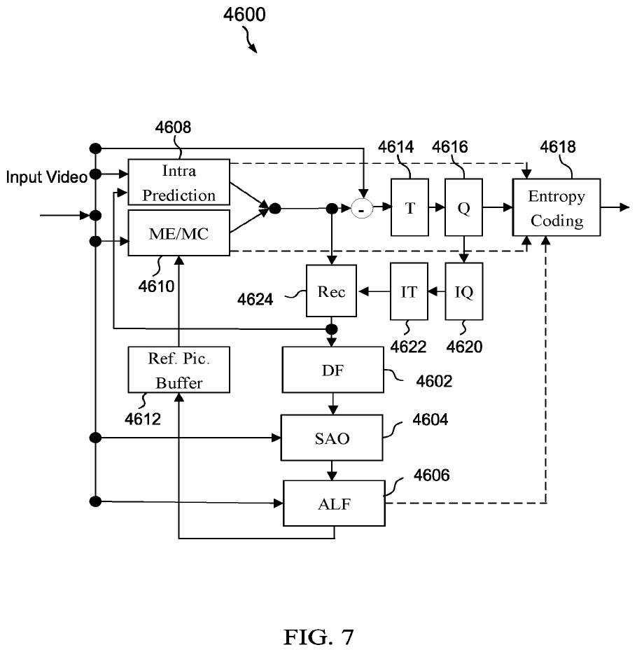

FIG. 7 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/motion compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.
1. A method for processing media data comprising: determining video data based on a multiview monochrome 16 profile; and performing a conversion between a visual media data and a bitstream based on the multiview monochrome 16 profile.
2. The method of solution 1, wherein a CompatibleProfileList comprises the following profiles: Multiview Monochrome 16, Multiview Monochrome 12, Multiview Monochrome 10, Multiview Monochrome, Monochrome 16, Monochrome 12, Monochrome 10, and Monochrome.
3. The method of any of solutions 1-2, wherein for a layer conforming to the Multiview Monochrome 16 profile, the value of chroma_format_idc is restricted to be equal to 0 only, the value of each of bit_depth_luma_minus8 and bit_depth_chroma_minus8 is restricted to be in the range of 0 to 8, inclusive, the value of each of transform_skip_rotation_enabled_flag, transform_skip_context_enabled_flag, implicit_rdpcm_enabled_flag, explicit_rdpcm_enabled_flag, intra_smoothing_disabled_flag, persistent_rice_adaptation_enabled_flag, log 2_max_transform_skip_block_size_minus2, extended_precision_processing_flag, and chroma_qp_offset_list_enabled_flag is restricted to be equal to 0 only.
4. The method of any of solutions 1-3, wherein for a layer conforming to the Multiview Monochrome 16 profile, the value of each of general_max_14bit_constraint_flag, sub_layer_max_14bit_constraint_flag[OpTid], general_max_12bit_constraint_flag, sub_layer_max_12bit_constraint_flag[OpTid], general_max_10bit_constraint_flag, sub_layer_max_10bit_constraint_flag[OpTid], general_max_8bit_constraint_flag, sub_layer_max_8bit_constraint_flag[OpTid], general_intra_constraint_flag, sub_layer_intra_constraint_flag[OpTid], general_one_picture_only_constraint_flag, and sub_layer_one_picture_only_constraint_flag[OpTid] is restricted to be equal to 0 only, and the value of each of general_max_422chroma_constraint_flag, sub_layer_max_422chroma_constraint_flag[OpTid], general_max_420chroma_constraint_flag, sub_layer_max_420chroma_constraint_flag[OpTid], general_max_monochrome_constraint_flag, sub_layer_max_monochrome_constraint_flag[OpTid], general_lower_bit_rate_constraint_flag, and sub_layer_lower_bit_rate_constraint_flag[OpTid] is restricted to be equal to 1 only.
5. The method of any of solutions 1-4, wherein for the Multiview Monochrome 16 profile, the value of each of the variables CpbVclFactor, CpbNalFactor, FormatCapabilityFactor, and MinCrScaleFactor is the same as that specified in Table A.10 for the Monochrome 16 profile.
6. The method of any of solutions 1-5, wherein an output layer set (OLS) is allowed to contain a layer conforming to the Multiview Monochrome 16 profile to have both texture layers and depth layers.
7. The method of any of solutions 1-6, wherein subBitstream is the bitstream of an OLS, and wherein when a layer in an OLS conforms to the Multiview Monochrome 16 profile, the following bitstream constraint is applied: No restriction is imposed on the profile to which the base layer of subBitstream conforms.
8. The method of any of solutions 1-7, wherein subBitstream is the bitstream of an OLS, and wherein when a layer in an OLS conforms to the Multiview Monochrome 16 profile, the following bitstream constraint is applied: All active SPSs for a layer conforming to the Multiview Monochrome 16 profile in subBitstream shall have chroma_format_idc equal to 0 only.
9. The method of any of solutions 1-8, wherein subBitstream is the bitstream of an OLS, and wherein when a layer in an OLS conforms to the Multiview Monochrome 16 profile, the following bitstream constraint is applied: ScalabilityId[j][smIdx] derived according to any active VPS shall be equal to 0 for any smIdx value not equal to 0 or 1 and for any value of j such that layer_id_in_nuh[j] is among layerIdListTarget that was used to derive subBitstream.
10. The method of any of solutions 1-9, wherein subBitstream is the bitstream of an OLS, and wherein when a layer in an OLS conforms to the Multiview Monochrome 16 profile, the following bitstream constraint is applied: For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, the value of bit_depth_luma_minus8 for layerA and the value of bit_depth_luma_minus8 for layerB shall be identical, the value of bit_depth_chroma_minus8 for layerA and the value of bit_depth_chroma_minus8 for layerB shall be identical, and DepthLayerFlag[i] shall be equal to DepthLayerFlag[j].
11. The method of any of solutions 1-10, wherein subBitstream is the bitstream of an OLS, and wherein when a layer in an OLS conforms to the Multiview Monochrome 16 profile, the following bitstream constraint is applied: For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
12. The method of any of solutions 1-11, wherein subBitstream is the bitstream of an OLS, and wherein when a layer in an OLS conforms to the Multiview Monochrome 16 profile, the following bitstream constraint is applied: When there are two different layers, a texture layer and a depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the depth layer shall be less than or equal to the values of pic_width_in_luma_samples and pic_height_in_luma_samples, respectively, in each active SPS for the texture layer.
13. The method of any of solutions 1-12, wherein an output layer set (OLS) containing a layer conforming to the Multiview Main 10 profile is allowed to have both texture layers and depth layers.
14. The method of any of solutions 1-13, wherein subBitstream is the bitstream of an OLS, and wherein when a layer in an OLS conforms to the Multiview Main 10 profile, the following bitstream constraint is applied: All active SPSs for a texture layer in subBitstream shall have chroma_format_idc equal to 1 only, and all active SPSs for a depth layer in subBitstream shall have chroma_format_idc equal to 0 only.
15. The method of any of solutions 1-14, wherein subBitstream is the bitstream of an OLS, and wherein when a layer in an OLS conforms to the Multiview Main 10 profile, the following bitstream constraint is applied: For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, and DepthLayerFlag[i] shall be equal to DepthLayerFlag[j].
16. The method of any of solutions 1-15, wherein subBitstream is the bitstream of an OLS, and wherein when a layer in an OLS conforms to the Multiview Main 10 profile, the following bitstream constraint is applied: ScalabilityId[j][smIdx] derived according to any active VPS shall be equal to 0 for any smIdx value not equal to 0 or 1 and for any value of j such that layer_id_in_nuh[j] is among layerIdListTarget that was used to derive subBitstream.
17. The method of any of solutions 1-16, wherein subBitstream is the bitstream of an OLS, and wherein when a layer in an OLS conforms to the Multiview Main 10 profile, the following bitstream constraint is applied: All active SPSs for a texture layer in subBitstream shall have bit_depth_luma_minus8 in the range of 0 to 2, inclusive, and all active SPSs for a depth layer in subBitstream shall have bit_depth_luma_minus8 in the range of 0 to 8, inclusive.
18. The method of any of solutions 1-17, wherein subBitstream is the bitstream of an OLS, and wherein when a layer in an OLS conforms to the Multiview Main 10 profile, the following bitstream constraint is applied: All active SPSs for a layer with nuh_layer_id equal to i and DepthLayerFlag[i] equal to 0 in subBitstream shall have bit_depth_chroma_minus8 in the range of 0 to 2, inclusive, and all active SPSs for a layer with nuh_layer_id equal to i and DepthLayerFlag[i] equal to 1 in subBitstream shall have bit_depth_chroma_minus8 in the range of 0 to 8, inclusive.
19. The method of any of solutions 1-18, wherein subBitstream is the bitstream of an OLS, and wherein when a layer in an OLS conforms to the Multiview Main 10 profile, the following bitstream constraint is applied: For a layer layerA with nuh_layer_id equal to i in subBitstream and another layer layerB with nuh_layer_id equal to j, when layerB is a reference layer of layerA, the value of bit_depth_luma_minus8 for layerA and the value of bit_depth_luma_minus8 for layerB shall be identical, and the value of bit_depth_chroma_minus8 for layerA and the value of bit_depth_chroma_minus8 for layerB shall be identical.
20. The method of any of solutions 1-19, wherein subBitstream is the bitstream of an OLS, and wherein when a layer in an OLS conforms to the Multiview Main 10 profile, the following bitstream constraint is applied: For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer.
21. The method of any of solutions 1-20, wherein subBitstream is the bitstream of an OLS, and wherein when a layer in an OLS conforms to the Multiview Main 10 profile, the following bitstream constraint is applied: When there are two different layers, a texture layer and a depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the depth layer shall be less than or equal to the values of pic_width_in_luma_samples and pic_height_in_luma_samples, respectively, in each active SPS for the texture layer.
22. The method of any of solutions 1-21, wherein an OLS containing a layer conforming to the Multiview Monochrome, Multiview Monochrome 10, or Multiview Monochrome 12 profile is allowed to have both texture layers and depth layers.
23. The method of any of solutions 1-22, wherein subBitstream is the bitstream of an OLS, and wherein when a layer in an OLS conforms to the Multiview Monochrome, Multiview Monochrome 10, or Multiview Monochrome 12 profile, one or more of the following bitstream constraints are applied: (1) No restriction is imposed on the profile to which the base layer of subBitstream conforms; (2) All active SPSs for a layer conforming to the Multiview Monochrome, Multiview Monochrome 10, or Multiview Monochrome 12 profile in subBitstream shall have chroma_format_idc equal to 0 only; (3) ScalabilityId[j][smIdx] derived according to any active VPS shall be equal to 0 for any smIdx value not equal to 0 or 1 and for any value of j such that layer_id_in_nuh[j] is among layerIdListTarget that was used to derive subBitstream; (4) For a layer layerA with nuh_layer_id equal to i in subBitstream and another layer layerB with nuh_layer_id equal to j, when layerB is a reference layer of layerA, the value of chroma_format_idc for layerA and the value of chroma_format_idc for layerB shall be identical, the value of bit_depth_luma_minus8 for layerA and the value of bit_depth_luma_minus8 for layerB shall be identical, the value of bit_depth_chroma_minus8 for layerA and the value of bit_depth_chroma_minus8 for layerB shall be identical, and DepthLayerFlag[i] shall be equal to DepthLayerFlag[j]; (5) For any layer in subBitstream, the values of pic_width_in_luma_samples and pic_height_in_luma_samples in each active SPS for that layer shall be equal to the values of pic_width_in_luma_samples and pic_height_in_luma_samples, respectively, in each active SPS for all reference layers of that layer; and (6) When there are two different layers, a texture layer and a depth layer, with nuh_layer_id equal to i and j in subBitstream, and ViewOrderIdx[i] is equal to ViewOrderIdx[j], the value of pic_width_in_luma_samples and pic_height_in_luma_samples in each active SPS for the depth layer shall be less than or equal to the values of pic_width_in_luma_samples and pic_height_in_luma_samples, respectively, in each active SPS for the texture layer.
24. The method of any of solutions 1-23, wherein the bit-depth of depth layer shall be no smaller than the luma bit-depth of texture layer.
25. An apparatus for processing video data comprising: a processor; and a non-transitory memory with instructions thereon, wherein the instructions upon execution by the processor, cause the processor to perform the method of any of solutions 1-24.
26. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-24.
27. A non-transitory computer-readable recording medium storing a bitstream of a video which is generated by a method performed by a video processing apparatus, wherein the method comprises: determining video data based on a multiview monochrome 16 profile; and generating a bitstream based on the determining.
28. A method for storing bitstream of a video comprising: determining video data based on a multiview monochrome 16 profile; generating a bitstream based on the determining; and storing the bitstream in a non-transitory computer-readable recording medium.
29. A method, apparatus, or system described in the present document.

The following solutions show further examples of techniques discussed herein.
1. A method for processing media data comprising: determining that a current layer in a sub-bitstream (subBitstream) conforms to a multiview format range extension profile, wherein all active sequence parameter sets (SPSs) for the current layer and a reference layer of the current layer shall include a chroma format identification code (chroma_format_idc) equal to 0 only; and performing a conversion between the visual media data and a bitstream based on the multiview format range extension profile.
2. The method of solution 1, wherein the multiview format range extension profile is a Multiview Monochrome profile.
3. The method of solution 1, wherein the multiview format range extension profile is a Multiview Monochrome 10 profile.
4. The method of solution 1, wherein the multiview format range extension profile is a Multiview Monochrome 12 profile.
5. The method of solution 1, wherein the multiview format range extension profile is a Multiview Monochrome 16 profile.
6. The method of any of solutions 1-5, wherein for the current layer (layerA) having network abstraction layer (NAL) unit header layer identifier (nuh_layer_id) equal to i, and another layer (layerB) with nuh_layer_id equal to j, when layerB is a reference layer of layerA, a value of bit depth luma minus eight (bit_depth_luma_minus8) for layerA and a value of bit_depth_luma_minus8 for layerB shall be identical, and a value of bit depth chroma minus eight (bit_depth_chroma_minus8) for layerA and a value of bit_depth_chroma_minus8 for layerB shall be identical.
7. The method of any of solutions 1-6, wherein for any layer in subBitstream, values of picture width in luma samples (pic_width_in_luma_samples) and picture height in luma samples (pic_height_in_luma_samples) in each active SPS for the layer shall be equal to values of pic_width_in_luma_samples and pic_height_in_luma_samples, respectively, in each active SPS for all reference layers of that layer.
8. The method of any of solutions 1-7, wherein an output layer set (OLS) containing the current layer conforming to the multiview format range extension profile is capable of including both texture layers and depth layers.
9. The method of any of solutions 1-8, wherein a base layer of subBitstream is not restricted from conforming to any multiview format range extension profile.
10. The method of any of solutions 1-9, wherein a scalability identifier for j and scalability mapping index (scalabilityId[j][smIdx]) derived according to any active video parameter set (VPS) shall be equal to 0 for any scalability mapping index (smIdx) value not equal to 0 or 1.
11. The method of any of solutions 1-10, wherein scalabilityId[j][smIdx] derived according to any active VPS shall be equal to 0 for any value of j such that layer identifier in NAL unit header j (layer_id_in_nuh[j]) is among layer identifier list target (layerIdListTarget) that was used to derive subBitstream.
12. The method of any of solutions 1-11, wherein when a texture layer with nuh_layer_id equal to i and a depth layer with nuh_layer_id equal to j are in subBitstream, and when view order index i (ViewOrderIdx[i]) is equal to view order index j (ViewOrderIdx[j]), values of pic_width_in_luma_samples and pic_height_in_luma_samples in each active SPS for the depth layer shall be less than or equal to the values of pic_width_in_luma_samples and pic_height_in_luma_samples, respectively, in each active SPS for the texture layer.
13. The method of any of solutions 1-12, wherein for the layerA having the nuh_layer_id equal to i, and the layerB with nuh_layer_id equal to j, when layerB is a reference layer of layerA, depth layer flag for i (DepthLayerFlag[i]) shall be equal to depth layer flag for j (DepthLayerFlag[j]).
14. The method of any of solutions 1-13, wherein the conversion includes encoding the visual media data into the bitstream.
15. The method of any of solutions 1-13, wherein the conversion includes decoding the visual media data from the bitstream.
16. An apparatus for processing video data comprising: a processor; and a non-transitory memory with instructions thereon, wherein the instructions upon execution by the processor, cause the processor to perform the method of any of solutions 1-15.
17. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-15.
18. A non-transitory computer-readable recording medium storing a bitstream of a video which is generated by a method performed by a video processing apparatus, wherein the method comprises: determining that a current layer in a sub-bitstream (subBitstream) conforms to a multiview format range extension profile, wherein all active sequence parameter sets (SPSs) for the current layer and a reference layer of the current layer shall include a chroma format identification code (chroma_format_idc) equal to 0 only; and generating a bitstream based on the determining.
19. A method for storing bitstream of a video comprising: determining that a current layer in a sub-bitstream (subBitstream) conforms to a multiview format range extension profile, wherein all active sequence parameter sets (SPSs) for the current layer and a reference layer of the current layer shall include a chroma format identification code (chroma_format_idc) equal to 0 only; generating a bitstream based on the determining; and storing the bitstream in a non-transitory computer-readable recording medium.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data comprising:
performing a conversion between the media data and a bitstream according to a format rule,
wherein the format rule specifies that when a current layer in a sub-bitstream (subBitstream) conforms to one of multiview format range extensions profiles, all active sequence parameter sets (SPSs) for the current layer and reference layers of the current layer shall have a chroma format identification code (chroma_format_idc) equal to 0 only.

2. The method of claim 1, wherein the multiview format range extensions profiles include one or more of a Multiview Monochrome profile, a Multiview Monochrome 10 profile, a Multiview Monochrome 12 profile or a Multiview Monochrome 16 profile.

3. The method of claim 2, wherein for a layer in an output operation point associated with an OLS in the bitstream, when the layer conforms to the Multiview Monochrome, Multiview Monochrome 10, Multiview Monochrome 12, or Multiview Monochrome 16 profile, the following applies: for the current layer (layerA) having network abstraction layer (NAL) unit header layer identifier (nuh_layer_id) equal to i, and another layer (layerB) with nuh_layer_id equal to j, when layerB is a reference layer of layerA, a value of bit depth luma minus eight (bit_depth_luma_minus8) for layerA and a value of bit_depth_luma_minus8 for layerB shall be identical, and a value of bit depth chroma minus eight (bit_depth_chroma_minus8) for layerA and a value of bit_depth_chroma_minus8 for layerB shall be identical, wherein i and j are integers.

4. The method of claim 2, wherein for a layer in an output operation point associated with an OLS in the bitstream, when the layer conforms to the Multiview Monochrome, Multiview Monochrome 10, Multiview Monochrome 12, or Multiview Monochrome 16 profile, the following applies: the layer and subBitstream shall obey the following constraints: values of picture width in luma samples (pic_width_in_luma_samples) and picture height in luma samples (pic_height_in_luma_samples) in each active SPS for the layer shall be equal to values of pic_width_in_luma_samples and pic_height_in_luma_samples, respectively, in each active SPS for all reference layers of that layer.

5. The method of claim 1, wherein an output layer set (OLS) containing the current layer conforming to the multiview format range extensions profiles is allowed to include both texture layers and depth layers.

6. The method of claim 1, wherein a base layer of subBitstream is not restricted from conforming to any one of the multiview format range extensions profiles.

7. The method of claim 1, wherein the conversion includes encoding the media data into the bitstream.

8. The method of claim 1, wherein the conversion includes decoding the media data from the bitstream.

9. An apparatus for processing video data comprising: a processor; and a non-transitory memory with instructions thereon, wherein the instructions upon execution by the processor, cause the processor to:
perform a conversion between media data and a bitstream according to a format rule,
wherein the format rule specifies that when a current layer in a sub-bitstream (subBitstream) conforms to one of multiview format range extensions profiles, all active sequence parameter sets (SPSs) for the current layer and reference layers of the current layer shall have a chroma format identification code (chroma_format_idc) equal to 0 only.

10. The apparatus of claim 9, wherein the multiview format range extensions profiles include one or more of a Multiview Monochrome profile, a Multiview Monochrome 10 profile, a Multiview Monochrome 12 profile or a Multiview Monochrome 16 profile.

11. The apparatus of claim 10, wherein for a layer in an output operation point associated with an OLS in the bitstream, when the layer conforms to the Multiview Monochrome, Multiview Monochrome 10, Multiview Monochrome 12, or Multiview Monochrome 16 profile, the following applies:
for the current layer (layerA) having network abstraction layer (NAL) unit header layer identifier (nuh_layer_id) equal to i, and another layer (layerB) with nuh_layer_id equal to j, when layerB is a reference layer of layerA, a value of bit depth luma minus eight (bit_depth_luma_minus8) for layerA and a value of bit_depth_luma_minus8 for layerB shall be identical, and a value of bit depth chroma minus eight (bit_depth_chroma_minus8) for layerA and a value of bit_depth_chroma_minus8 for layerB shall be identical, wherein i and j are integers; and
the layer and subBitstream shall obey the following constraints: values of picture width in luma samples (pic_width_in_luma_samples) and picture height in luma samples (pic_height_in_luma_samples) in each active SPS for the layer shall be equal to values of pic_width_in_luma_samples and pic_height_in_luma_samples, respectively, in each active SPS for all reference layers of that layer.

12. The apparatus of claim 9, wherein an output layer set (OLS) containing the current layer conforming to the multiview format range extensions profiles is allowed to include both texture layers and depth layers.

13. The apparatus of claim 9, wherein a base layer of subBitstream is not restricted from conforming to any one of the multiview format range extensions profiles.

14. A non-transitory computer readable storage medium storing instructions that cause a processor to:
perform a conversion between a media data and a bitstream according to a format rule,
wherein the format rule specifies that when a current layer in a sub-bitstream (subBitstream) conforms to one of multiview format range extensions profiles, all active sequence parameter sets (SPSs) for the current layer and reference layers of the current layer shall have a chroma format identification code (chroma_format_idc) equal to 0 only.

15. The non-transitory computer readable storage medium of claim 14, wherein the multiview format range extensions profiles include one or more of a Multiview Monochrome profile, a Multiview Monochrome 10 profile, a Multiview Monochrome 12 profile or a Multiview Monochrome 16 profile.

16. The non-transitory computer readable storage medium of claim 15, wherein for a layer in an output operation point associated with an OLS in the bitstream, when the layer conforms to the Multiview Monochrome, Multiview Monochrome 10, Multiview Monochrome 12, or Multiview Monochrome 16 profile, the following applies:
for the current layer (layerA) having network abstraction layer (NAL) unit header layer identifier (nuh_layer_id) equal to i, and another layer (layerB) with nuh_layer_id equal to j, when layerB is a reference layer of layerA, a value of bit depth luma minus eight (bit_depth_luma_minus8) for layerA and a value of bit_depth_luma_minus8 for layerB shall be identical, and a value of bit depth chroma minus eight (bit_depth_chroma_minus8) for layerA and a value of bit_depth_chroma_minus8 for layerB shall be identical, wherein i and j are integers; and
the layer and subBitstream shall obey the following constraints: values of picture width in luma samples (pic_width_in_luma_samples) and picture height in luma samples (pic_height_in_luma_samples) in each active SPS for the layer shall be equal to values of pic_width_in_luma_samples and pic_height_in_luma_samples, respectively, in each active SPS for all reference layers of that layer.

17. The non-transitory computer readable storage medium of claim 14, wherein an output layer set (OLS) containing the current layer conforming to the multiview format range extensions profiles is allowed to include both texture layers and depth layers.

18. The non-transitory computer readable storage medium of claim 14, wherein a base layer of subBitstream is not restricted from conforming to any one of the multiview format range extensions profiles.

19. A non-transitory computer-readable recording medium storing a bitstream of a video which is generated by a method performed by a video processing apparatus, wherein the method comprises:
generating the bitstream according to a format rule,
wherein the format rule specifies that when a current layer in a sub-bitstream (subBitstream) conforms to one of multiview format range extensions profiles, all active sequence parameter sets (SPSs) for the current layer and reference layers of the current layer shall have a chroma format identification code (chroma_format_idc) equal to 0 only.

20. The non-transitory computer-readable recording medium of claim 19, wherein the multiview format range extensions profiles include one or more of a Multiview Monochrome profile, a Multiview Monochrome 10 profile, a Multiview Monochrome 12 profile or a Multiview Monochrome 16 profile;
wherein for a layer in an output operation point associated with an OLS in the bitstream, when the layer conforms to the Multiview Monochrome, Multiview Monochrome 10, Multiview Monochrome 12, or Multiview Monochrome 16 profile, the following applies:
for the current layer (layerA) having network abstraction layer (NAL) unit header layer identifier (nuh_layer_id) equal to i, and another layer (layerB) with nuh_layer_id equal to j, when layerB is a reference layer of layerA, a value of bit depth luma minus eight (bit_depth_luma_minus8) for layerA and a value of bit_depth_luma_minus8 for layerB shall be identical, and a value of bit depth chroma minus eight (bit_depth_chroma_minus8) for layerA and a value of bit_depth_chroma_minus8 for layerB shall be identical, wherein i and j are integers;
the layer and subBitstream shall obey the following constraints: values of picture width in luma samples (pic_width_in_luma_samples) and picture height in luma samples (pic_height_in_luma_samples) in each active SPS for the layer shall be equal to values of pic_width_in_luma_samples and pic_height_in_luma_samples, respectively, in each active SPS for all reference layers of that layer;
wherein an output layer set (OLS) containing the current layer conforming to the multiview format range extensions profiles is allowed to include both texture layers and depth layers; and
wherein abase layer of subBitstream is not restricted from conforming to any one of the multiview format range extensions profiles.
